(19) United States
(12) Patent Application Publication
(10) Pub. No.: US 2014/0012766 A1
(43) Pub. Date: Jan. 9, 2014

(54) INVENTIVE CONCEPTS ENABLED SEMI-AUTOMATIC TESTS OF PATENTS

(71) Applicant: Sigram SCHINDLER, Berlin (DE)

(72) Inventor: Sigram SCHINDLER, Berlin (DE)

(21) Appl. No.: 13/923,630

(22) Filed: Jun. 21, 2013

Related U.S. Application Data
(63) Continuation-in-part of application No. 13/777,416, filed on Feb. 26, 2013.
Application No. 13/777,416 is a continuation-in-part of application No. 13/608,543, filed on Sep. 10, 2012.
Application No. 13/608,543 is a continuation of application No. 12/756,254, filed on Apr. 8, 2010, now abandoned.
Application No. 13/608,543 is a continuation-in-part of application No. 13/229,362, filed on Sep. 9, 2011, now abandoned.
Application No. 13/229,362 is a continuation-in-part of application No. 13/093,682, filed on Apr. 25, 2011, now abandoned.
(60) Provisional application No. 61/704,848, filed on Sep. 24, 2012.
(60) Provisional application No. 61/708,253, filed on Oct. 1, 2012.
(60) Provisional application No. 61/710,219, filed on Oct. 5, 2012.
(60) Provisional application No. 61/717,706, filed on Oct. 24, 2012.
(60) Provisional application No. 61/736,715, filed on Dec. 13, 2012.
(60) Provisional application No. 61/750,084, filed on Jan. 8, 2013.
(60) Provisional application No. 61/533,499, filed on Sep. 12, 2011.
(60) Provisional application No. 61/537,202, filed on Sep. 21, 2011.
(60) Provisional application No. 61/539,699, filed on Sep. 27, 2011.
(60) Provisional application No. 61/542,988, filed on Oct. 4, 2011.
(60) Provisional application No. 61/546,187, filed on Oct. 12, 2011.
(60) Provisional application No. 61/569,534, filed on Dec. 12, 2011.
(60) Provisional application No. 61/590,474, filed on Jan. 25, 2012.
(60) Provisional application No. 61/592,072, filed on Jan. 30, 2012.
(60) Provisional application No. 61/599,607, filed on Feb. 16, 2012.
(60) Provisional application No. 61/610,656, filed on Mar. 14, 2012.
(60) Provisional application No. 61/614,827, filed on Mar. 23, 2012.
(60) Provisional application No. 61/622,653, filed on Apr. 11, 2012.
(60) Provisional application No. 61/624,554, filed on Apr. 16, 2012.
(60) Provisional application No. 61/639,270, filed on Apr. 27, 2012.
(60) Provisional application No. 61/656,286, filed on Jun. 6, 2012.
(60) Provisional application No. 61/671,977, filed on Jul. 16, 2012.
(60) Provisional application No. 61/673,525, filed on Jul. 19, 2012.
(60) Provisional application No. 61/680,420, filed on Aug. 7, 2012.
(60) Provisional application No. 61/683,377, filed on Aug. 15, 2012.
(60) Provisional application No. 61/684,899, filed on Aug. 20, 2012.
(60) Provisional application No. 61/697,593, filed on Sep. 6, 2012.
(60) Provisional application No. 61/319,088, filed on Mar. 30, 2010.
(60) Provisional application No. 61/313,860, filed on Mar. 15, 2010.
(60) Provisional application No. 61/304,549, filed on Feb. 15, 2010.
(60) Provisional application No. 61/296,089, filed on Jan. 19, 2010.
(60) Provisional application No. 61/263,679, filed on Nov. 23, 2009.
(60) Provisional application No. 61/261,585, filed on Nov. 16, 2009.
(60) Provisional application No. 61/259,930, filed on Nov. 10, 2009.
(60) Provisional application No. 61/255,372, filed on Oct. 27, 2009.
(60) Provisional application No. 61/252,894, filed on Oct. 19, 2009.
(60) Provisional application No. 61/240,401, filed on Sep. 8, 2009.
(60) Provisional application No. 61/236,366, filed on Aug. 24, 2009.
(60) Provisional application No. 61/234,376, filed on Aug. 17, 2009.
(60) Provisional application No. 61/227,565, filed on Jul. 22, 2009.
(60) Provisional application No. 61/223,127, filed on Jul. 6, 2009.
(60) Provisional application No. 61/219,209, filed on Jun. 22, 2009.
(60) Provisional application No. 61/184,938, filed on Jun. 8, 2009.
(60) Provisional application No. 61/183,279, filed on Jun. 2, 2009.
(60) Provisional application No. 61/181,998, filed on May 28, 2009.
(60) Provisional application No. 61/170,217, filed on Apr. 17, 2009.
(60) Provisional application No. 61/169,159, filed on Apr. 14, 2009.
(60) Provisional application No. 61/168,036, filed on Apr. 9, 2009.
(60) Provisional application No. 61/497,140, filed on Jun. 15, 2011.
(60) Provisional application No. 61/504,435, filed on Jul. 5, 2011.
(60) Provisional application No. 61/515,493, filed on Aug. 5, 2011.
(60) Provisional application No. 61/522,865, filed on Aug. 12, 2011.
(60) Provisional application No. 61/526,831, filed on Aug. 24, 2011.
(60) Provisional application No. 61/528,431, filed on Aug. 29, 2011.
(60) Provisional application No. 61/531,358, filed on Sep. 6, 2011.
(60) Provisional application No. 61/352,528, filed on Jun. 8, 2010.
(60) Provisional application No. 61/374,312, filed on Aug. 17, 2010.
(60) Provisional application No. 61/380,377, filed on Sep. 7, 2010.
(60) Provisional application No. 61/384,770, filed on Sep. 21, 2010.
(60) Provisional application No. 61/387,217, filed on Sep. 28, 2010.
(60) Provisional application No. 61/389,829, filed on Oct. 5, 2010.
(60) Provisional application No. 61/394,822, filed on Oct. 20, 2010.
(60) Provisional application No. 61/407,076, filed on Oct. 27, 2010.
(60) Provisional application No. 61/408,291, filed on Oct. 29, 2010.
(60) Provisional application No. 61/408,790, filed on Nov. 1, 2010.
(60) Provisional application No. 61/410,066, filed on Nov. 4, 2010.
(60) Provisional application No. 61/410,971, filed on Nov. 8, 2010.
(60) Provisional application No. 61/412,822, filed on Nov. 12, 2010.
(60) Provisional application No. 61/413,517, filed on Nov. 15, 2010.
(60) Provisional application No. 61/414,483, filed on Nov. 17, 2010.
(60) Provisional application No. 61/415,021, filed on Nov. 18, 2010.
(60) Provisional application No. 61/415,964, filed on Nov. 22, 2010.
(60) Provisional application No. 61/416,478, filed on Nov. 23, 2010.
(60) Provisional application No. 61/417,330, filed on Nov. 26, 2010.
(60) Provisional application No. 61/417,477, filed on Nov. 29, 2010.
(60) Provisional application No. 61/418,179, filed on Nov. 30, 2010.
(60) Provisional application No. 61/420,058, filed on Dec. 6, 2010.
(60) Provisional application No. 61/426,825, filed on Dec. 23, 2010.
(60) Provisional application No. 61/427,244, filed on Dec. 27, 2010.
(60) Provisional application No. 61/428,941, filed on Dec. 31, 2010.
(60) Provisional application No. 61/431,129, filed on Jan. 10, 2011.
(60) Provisional application No. 61/435,551, filed on Jan. 24, 2011.
(60) Provisional application No. 61/440,053, filed on Feb. 7, 2011.
(60) Provisional application No. 61/442,896, filed on Feb. 15, 2011.
(60) Provisional application No. 61/447,401, filed on Feb. 28, 2011.
(60) Provisional application No. 61/472,915, filed on Apr. 7, 2011.
(60) Provisional application No. 61/476,162, filed on Apr. 15, 2011.
(60) Provisional application No. 61/477,870, filed on Apr. 21, 2011.
(60) Provisional application No. 61/803,631, filed on Mar. 20, 2013.
(60) Provisional application No. 61/814,492, filed on Apr. 22, 2013.
(60) Provisional application No. 61/820,932, filed on May 8, 2013.

(51) Int. Cl. G06Q 50/18; G06F 17/27

(52) U.S. Cl. CPC G06Q 50/184; G06F 17/2775
USPC 705/310

(57) ABSTRACT

This patent (application) discloses for a claimed invention 10 tests (+their 5 controls) enabled by its inventive concepts, automatically prompting their user through exploratively checking its meeting the requirements stated by
§112, “well-definedness of its inventive concepts”, i.e. their 1) disaggregation into elementary ones, 2) disclosures, 3) definitiveness, and 4) enablement;
§§102/103, “novelty/nonobviousness of this invention”, i.e. its 7) creativity/inventivity, after having assessed their 5) independence, and 6) non-equivalence;
§101, “patent-eligibility of it and its claim”, i.e. its not only being 8) a natural law, or 9) idempotent, or 10) an abstract idea alias preemptive,
   and then being automatically affirmatively reproducible in real-time.

These inventive concepts represent this claimed invention's legal and technical facts under 35 USC §§112/102/103/101—and other patent laws' peer sections, e.g. EPC's §§52-57, 69—required by Highest Courts for “model based” inventions, i.e. from advanced technologies.

### I. TESTS ENABLED BY A CLAIMED INVENTION'S INVENTIVE CONCEPTS

This patent application is a continuation in part of a preceding patent application¹ and refers often to this document's terms/notions by a trailing index “^{w):xxxx}*”, whereby “w” identifies a footnote quoting a document and “xxxx” identifies sections or pages or footnotes or definitions, . . . therein. E.g. when stating: A claimed invention's maximal set of independent inventive concepts over RS is unique modulo isomorphisms^{1):Theorom 1}.

Any invention and its potential innovation—embodying technically creative resp. inventive aspects, “technically” meaning “a technique embodying”, this technique not being limited to a “machine or transformation^{1):7)}—comprises a technique teaching, TT.0 alias “claimed invention”, disclosed and claimed by a patent.0's “inventive concepts” being well-defined, novel, nonobvious, . . . over pertinent ordinary skill and creativity (“pose”) and prior art, as of a reference set RS of patent.i's disclosing TT.i's, 1≦i—l. Thereby the meanings of the terms describing a TT.i are to be derived from the resp. patent.i specifications, i≧0, as interpreted by the person of pose, according to the Mayo/Myriad decisions by the Supreme Court, and the underlying Markman/Phillips decisions by the US CAFC.

These US Highest Courts' decisions are landmarks on the way to firm ground to base on claim construction as of 35 USC; its peer in the EU is the EPC. The Mayo decision neatly complements the Phillips decision: The meaning of its decisive statements “The inquiry into how a person of ordinary skill in the art understands a claim term provides an objective baseline from which to begin claim interpretation.” and “claims must be read in view of the specification, of which they are part”, quoting Markman v. Westview Instruments is—as to the meaning of the term “baseline in view of the specification”—just further going elaborated on by the Mayo decision. Namely: It implies that the “baseline”²), to be understood in view of the specification, got to be identified by the “inventive concepts” of the claimed invention disclosed by its specification. Hence, the Mayo decision and its “inventive concepts” induce filling terminological/notional gaps in US patent precedents—left open by the Phillips decision—according to advanced IT (i.e. KR, NL, DL research). E.g.: Any inventive concept represents^{II.3.2} a “legal fact” as well as a “technical fact” of the claimed invention—which here again¹⁾ is assumed to be non-pathologic.

A claimed invention's checks under §§112,102,103,101 thus means testing, first of all, its inventive concepts—as constituents of its “base line”—whether they meet these 4 35 USC Sections' requirements. Actually, the claimed invention's inventive concepts enable the here disclosed 10+ abstract tests'^{III.} of them and their claimed invention; their applications implement the claimed invention's complete check under 35 USC §§112/102/103/101.

Their 20+ applications are this patent application's claimed inventions. The problem solved by a test is, for a given PTR, to automatically prompt an IES user through its explorative execution and store its results in PTR-DS so that it enables an IES then to automatically and instantly confirmatively reproduce it for its user on his query.

### II. AUTOMATIC SUPPORT OF TESTING PATENT APPLICATIONS UNDER 35 USC AND EPC, INVENTIVE CONCEPTS, AND THE REFINED CLAIM CONSTRUCTION IMPLIED

Section I outlined the introduction of the new term/notion “inventive concept” of a claimed invention—being a significantly refined notion of the EU notion of “inventive step”—into the US patent precedents¹⁾. Sections III and IV describe the here claimed inventions/tests by already intensively using this new term/notion, i.e. they assume the massive practical advantages coming along with it are known. Section II thus provides this missing link:
It starts with introducing in II.1 and II.2 ground laying mathematical and legal terms/notions needed for being precise about the meanings of a regional patent law's clauses and their interpretations by their Highest Courts' decisions. Here the 35 USC is used and therein §§101/102/103/112, as interpreted by the Supreme Court's KSR/Bilski/Mayo/Myriad line of decisions. The EU peers are e.g. the §§52-77 and 59 of the EPC.
It then explains in II.3.1, in a colloquial way, what at all this new term/notion “inventive concept” has to do with the terms in specifications'/claims' wordings and how to use it, in II.3.2 how to use trivial mathematical notation for becoming complete, precise, and unmistakable in interpreting/applying 35 USC and Highest Courts recent patent precedents, and in II.3.3 that and why a “model based” claimed invention—when tested for patentability (§§102/103) and patent-eligibility (§101)—needs this rigorous thinking in terms of inventive concepts, implying completing the classical claim construction for it to a refined claim construction (§112), which in turn enables identifying 10 new “aspects” thereof (as recently asked for by the CAFC) owned by it iff it meets all the requirements stated by the §§112/102/103/101. Verifying that it does own them all may be vastly supported automatically by 10 “FSTP tests”. This eventually leads to the claimed inventions of this patent application.
II.4 discusses the two refinement techniques known from IT system design, based on “levels of abstraction” resp. “separable concerns”, the above term/notion of “aspect” being a synonym of this term/notion of “concern”.
II.5 finally leverages on II.3.3 and II.4 by first briefly summarizing the necessity of their notions and then showing also their sufficiency, by outlining the semantics of these 10 “aspects”/“concerns” of a claimed invention and proving that they enable deciding whether it meets these 4 §§of 35 USC as interpreted by the Supreme Court.

Thus, Section II does not specify the claimed inventions of this patent application, but—as there are solely the Supreme Court's KSFVBiIski/Mayo/Myriad decisions and the CAFC's efforts of putting them into operational measures—it provides to all interested parties an easy to grasp introduction into this next higher step of evolution of the US patent precedents, fully in line with advanced IT. While the first addressees of Section II hence are PTOs' staffs, for enabling them to examine the subject matter of the below claimed inventions, even more important will be that it smoothens this way up for the courts involved in this shift of paradigm. The scientific community—here researchers from advanced IT and from analytic philosophy, but also from areas of its application, e.g. from business, neurology, molecular biology, . . . technologies—always rapidly joins in leveraging on new and dramatically enlightening insights, which in this case enjoy the extraordinary charm of being requested by the US Highest Courts.

### II.1—Increased Preciseness of Patent Analysis and Precedents by Mathematical Modeling/Notations

The Sections II.1 and II.2 need to be read only when their terms/notions are encountered in what follows.

The pair <TT.0, RS> is here called “PTR” (“Pair of TT.0 and RS” alias “Problem of TT.0 and RS”)¹⁾, TT.0 being a claimed invention. It comprises informal and formal descriptions of its TT.i's, derived from its “doc.i's” annotated items of information. A description is “formal”, iff it is exact for the person of pertinent ordinary skill. More precisely, it must identify all
(a) X.i.n, 1≦n≦N, 0≦i≦l as N “elements” and “peer elements” of its TT.0 resp. TT.i's disclosed by doc.i,
(b) X.i.n, 1≦n≦N, 0≦i≦l as “predicates” alias “attributes” alias “properties” of these elements (X.i.n's),
(c) C.kⁿ, 1≦kⁿ≦Kⁿ, Σ^{1≦n≦N}Kⁿ=K as “concepts”, defining TT.0's N predicates by Λ^{1≦kn≦Kn}C.kⁿ=X.0.n, 1≦n≦N^{II.3.2}.

The “PTR analysis”—ignoring its o-/BAD-/BID “knowledge representations, KRs”—comprises:
(d) a “reference set, RS”, the set of TT.i's disclosed by doc.i, 1≦i≦l, being its TT.0's prior art.
(e) “technical fundamental informal facts”, being disclosures of all TT.i properties in doc.i, 0≦i≦l.
(f) “technical fundamental formal facts”, being X's properties precise descriptions by the above X.i.n's.
(g) “technical primary facts”, the “anticipates/not-anticipates-not-contradicts/contradicts, ANC”¹⁾ relation between all X.i.n's, i>0, and X.0.n's (i.e. the US “Graham technical facts”).

### II.2—Further Elementary Mathematical Terms/Notions Describing Highest Courts' Patent Precedents

Precisely modeling Highest Courts' notions of “independent thoughts”^{1):4)} and “inventive concepts” requires further FSTP notions¹⁾—needed in Sections III/IV, i.e. not yet here but introduced for showing where this “patent technique” is heading at. They all are seemingly in line with all national patent systems, principally. They are defined (abbr. “≈”), next, by tolerating some vagueness until the notion of “concept” is clearly defined^{II.3.2}. These are:
“anticipation-combination, AC”≈any N-tupel ∈ps+pa*, whereby “ps+pa*”≈the set of the (l+1)**N N-tupels, any one of their N components being either an X.i.n (1≦i≦l) or some ∈ps, “AC^{ps}” having all N components ∈ps,
“q-CC”≈a sequence of q 1-CCs^{1):4)} of “concept creations” in an AC, q=0, 1, 2, . . . , “0-CC”≈null-creation,
“Q^{pics}-AC”≈any AC:∃Q^{pics}-CC with Q^{pics}-AC/mod(Q^{pics}-CC) ants TT.0, with Q^{pics} being minimal.

Let for AC and q-CC, q=0, 1, 2, . . . , the anticipation relation of “AC/mod(q-CC) to TT.0”¹⁾ be called:
i) “contradictionless”, iff “AC/mod(q-CC) not-contradicts (TT.0 or any TT.i involved in this AC)”, q≦0.
ii) “element integrity preserving”, iff AC/mod(q-CC) ants TT.0 “element-wise/element-by-element”.
   To i): In Highest Courts' precedents, a TT.i contradicting TT.0 often is to be excluded from any AC, as TT.i then “teaches away” the skilled person from deriving TT.0 from the given prior art RS¹⁾.
   To ii): All Highest Courts' precedents agree: An AC must neither be .) “cherry-picking” X.i.n_{φ.o}'s from different TT.i's, i>0—if an X.0.n and some peer X.i.n's are conjunctions of resp. several X.i.n_{φ.i}, 0≦i≦l, cp.i=1, 2, 3, . . . —for ant-ing of TT.0 its X.0.n, nor :) combining more than maximally 3 doc.i's.

### II.3—Inventive Concepts, Refining Claim Construction Accordingly, and its 10 New “Aspects”

### II.3.1—Explaining the Notion of “Inventive Concept” by a Practical Example

The example used subsequently is the US patent “'902”¹⁾ from the area of telecommunication technology. Its claimed invention and the latter's inventive concepts disclose/describe and solve the problem to guarantee the real-time property of its data transfer, making it suitable for Internet telephony—today called “VoIP”.
(I) To identify for a claimed invention its “inventive concepts” has been explicitly asked for by the Supreme Court's Mayo decision as the basis for legally deciding about its patentability and patent-eligibility by enabling it to test it by 35 USC §§112/102/103/101. They enable determining its amount and kinds of inventivity/creativity—“creativity” (implicitly addressed by the Supreme Court's KSR decision already) being part of the more recent term “inventivity”, as follows: An inventive concept of a claimed invention is not only one of its “technical facts” but also the “legal fact” underlying it^{II.3.2}. Thus, an inventive concept is a claimed invention's legal fact establishing its respective technical fact, i.e. represents a notional tupel. Thus, for a technical fact of an invention to be relevant in its test under one of these four sections, it trivially got to be a legal fact, first of all. According to the Supreme Court's unanimous KSR/Bilski/Mayo/Myriad decisions “inventive concepts” identify, of a claimed invention, those elements and their properties distinguishing it legally and technically from prior art. Nevertheless, for simplification, in (II)-(X) the legal fact aspect of an inventive concept is totally ignored—it is evident anyway^{II.3.2}.
(II) Four exemplary inventive concepts disclosed by the '902 specification are: (a) “Communications connection of a Telephone Call”; (b) “Proactive Signal”; (c) “Change-Over of an Individual Communications Connection” preserving real-time quality; (d) “Practicable on any Packet—and any Line-switching Network”³⁾.
(III) Inventive concepts are artificial notions representing the mental building blocks of any patent law and patent, i.e. are in everyday practical use. Their uniform pragmatics is to award rapidly publishing an insight into a technical invention of whatsoever kind—by a temporary monopoly on its use—for rapidly sharing this new insight with publicity and thus accelerating creating interest in the invention's rapid use and gaining further insights on top of it. The notion of inventive concepts initially seems sophisticated, which only shows, how complex this thinking underlying patent law actually is, as to its social beneficial efficiency, for the public and the inventor—often ignored by contemporary discussions. Nevertheless, inventive concepts are easy to use, once used to them.

To begin with, the names of inventive concepts may be freely chosen by the person analyzing the patent at issue to be self-descriptive in natural language (of the person of ordinary skill and creativity, “pose”)—e.g. as for the seven inventive concepts of claimed '902 invention named in (II) and ftn 3, there printed in bold letters. I.e., they may use terms different from those used by their disclosures (whereby these may be graphical) and/or by the specifications'/claims' wordings (up to the above Phillips decision). Inventive concepts even need not be disclosed explicitly by the specification, as they may be implicitly disclosed, if this only holds for the pose. Inventive concepts embodied by a claimed invention usually are “refinements”^{II.3.3} of the functional and/or non-functional properties of its elements^{II.1}, i.e. of their classical “limitations”—occasionally also “abstractions”^{II.3.3}.
(IV) All that matters is: A claimed invention embodies inventive concepts disclosed by its specification, which make the claimed invention and its specification meet the requirements stated by 35 USC §§112/102/103/101—also representing the advantages, which this claimed invention actually embodies over pertinent ordinary skill and prior art—and enable clear such assessments impossible without them, whereby in particular (V)-(VII) applies.
(V) Firstly, inventive concepts/properties may be compound vs. elementary. Testing compound inventive concepts under these four Sections of 35 USC often is misleading¹⁾. E.g.: Of a parcel handling invention, the “adjustability to the volume of parcels” may be an elementary inventive concept, while in another parcel handling invention the “adjustability to the volume of parcels” may be a compound inventive concept, as it is capable of practicing different procedures for substantially cubical and for substantially non-cubical parcels of the same volume—then the parcels' volume and two of their edge lengths may be three elementary ones of its inventive concepts. Evidently, applying these 4 tests to a claimed invention's inventive concepts, one of which is compound, means inviting problems. Thus, a claimed invention's inventive concepts are called “disaggregated into elementary inventive concepts” iff the tests addressed in (VI) resp. Section III are dependably executable on them and their further disaggregation into allegedly more elementary inventive concepts must be reversed due to one of these tests.
(VI) Secondly, there are several further reasons why for many claimed inventions not all their allegedly technical elementary facts are suitable for their inventive concepts—e.g. they then may depend on other inventive concepts, or were equivalent to prior art, or . . . (see Section III)—and none of them is an inventive concept^{II.3.2}.
(VII) Thirdly, it is important to note that for “model based” claimed inventions—potentially to be tested for an abstract idea, such as a “computer-implemented invention”⁴ or a “human genome invention”⁵—these models always implicitly underlie the resp. specifications. These models are often commonly understood, although not quite clear, such as the commonly known and neither clear nor complete human genome model (“DNA model”). Such deficiencies of models used are tolerable, as by means of them the claimed invention and its inventive concepts as well as the problem it is supposed to solve may nevertheless be precisely described by the resp. specifications (e.g. the inventive concepts of a human genome based invention on top of the DNA model, i.e. using it)—and it is the claimed invention to which the patent is granted, not to the model underlying its specification.

(VIII) and (IX) now explain in more detail the being of the exemplary '902 inventive concepts of (II).
(VIII) The below listed items (a)-(d) describe, for the '902 invention, the technical facts of the four '902 in-Cs, disclosed by the '902 specification (as underlying all '902 claims, as repeatedly stated by the Phillips decision, e.g. by: “The specification must teach and enable all the claims, . . . ” page 33, emphasis added).
   (a) “Communications connection of a telephone call over the Internet”. This inventive '902 concept—mentioned by neither pertinent ordinary skill nor by a prior art document (this stereotypic phrase omitted in the sequel)—describes properties of a telephone call over the Internet. Namely, to be:
      an end-terminal-to-end-terminal connection (i.e.: an end-terminal-user-to-end-terminal-user connection, as an end-terminal “telephone” does not “communicate” with another telephone, but just “interacts” with it, as understood by the person of ordinary skill, according to the ISO-OSI-Reference Model⁶), and
      concerned with initializing a telephone call over the Internet and then realizing a real-time data transfer between these end-terminals suitable for telephony, as soon as this call is established. The latter means for the person of ordinary skill: Guaranteeing an end-terminal-to-end-terminal data transfer of a bandwidth of approximately 8 kbit/sec and a delay of maximally 0.5 seconds.

This inventive concept is disclosed by the '902 specification in col. 2, II. 19-25.
(b) “Proactive Signal”. This inventive '902 concept describes a property of the control command triggering the change-over of the telephone call. Namely, to be automatically released as soon as the monitoring of the data transfer of the communications connection of the telephone call indicates that in a point monitored—e.g. a buffer monitored in one of its two switches—a defect in this data transfer is detected.

This inventive concept is disclosed by the '902 specification in col. 9, II. 41-47.
(c) “Real-time change over of a communications connection”. This inventive '902 concept, disclosed by the '902 specification in col. 9, II. 48-55. describes the capability of a communications connection to:
   anytime instantly change-over from a packet-switching to a line-switching network, in particular without necessarily first establishing another hand-shaking protocol (e.g. X.25, TCP, VT.100) between the connected end-terminals or systems the communications connection traverses, and
   be changed-over individually, i.e. without forcing by its change-over another communications connection also to change-over.
(d) “Practicable of the '902 invention on any line—and any packet-switching network”. This inventive '902 concept describes the property of the '902 data transfer technique, to be practicable on any packet-switching network and any line-switching network, to which its two switches may simultaneously be connected. This inventive concept is disclosed by the '902 specification in col. 6, II. 52-56.

(IX) The features of the '902 invention represented by the above four inventive '902 concepts are specified by their disclosures in the '902 specification identified in the last lines of the preceding paragraphs (a)-(d). The advantage that any one of these four inventive concepts (embodied by the '902 invention) represents, is explained by a kind of real life metaphor for it, which may often be put as “from . . . to . . . ,” for brevity called “metaphor”. Illustrating the meanings of the inventive concepts in that expressive terms greatly facilitates immediately recognizing that any one of them describes a substantial improvement achieved by the claimed invention over the state of the prior art referred to, i.e. that the claimed invention is really inventive/creative.

The following item list (a′)-(d′) provides such metaphors for the inventive concepts (a)-(d) from (II)/(VIII).
(a′) The improvement over prior art described by the inventive '902 concept “Communications connection of a telephone call over the Internet” is illustrated by the metaphor “from dream to reality”. This metaphor for said inventive concept namely conveys that the claimed '902 invention:
   terminates the long-time existing “dream”—indeed being a misbelief—that a telephone call over the Internet works already fine if only the Internet works fine, and instead
   takes into account the “reality” that also the other devices outside of the Internet necessary for the technically much more complex establishment of the communications connection of an Internet telephone call (than of the one of a classical telephone call) must work correctly, in particular its two '902 switches. At the '902 priority date that requirement was not considered due to the additional and then expensive resources it implied for Internet telephony (by contrast to classical telephony), e.g. enough buffer space and appropriate compression/decompression chips.
(b′) The improvement over prior art described by the inventive '902 concept “Proactive Signal” is illustrated by the metaphor “from inflatable life vest to air bag”. This metaphor conveys: The claimed '902 invention:
   does not wait with releasing the change-over command until a loss of the quality of the telephone call has Occurred—and then waits until that said loss actually occurs and only then releases the change-over command, just like a “life vest” is inflated only after having landed on water—
   but proactively releases the change-over command as soon as some monitoring of the data transfer for the telephone call detects somewhere therein—i.e. in the communications connection at issue—a threat of loss of quality, as there is a problem with its bandwidth or packet forwarding, just like an “air bag” in a car goes off if a sensor detects a threat of accident.

I.e., the Proactive Signal inventive concept says that in the claimed '902 invention the change-over of the data transfer of the communications connection of an Internet call goes off prior to any loss of quality occurring therein. Sometimes this even may happen although this loss would not have occurred at all—as the problem detected would by its own have disappeared a few milliseconds after that point in time of releasing the '902 change-over command.
(c′) The improvement over prior art described by the inventive '902 concept “Real-time change over of a communications connection” is illustrated by the metaphor “from mass transit to individual transit”. This metaphor for said inventive concept conveys that the claimed '902 invention:
   does not exert just mass transit between '902 switches, i.e. uniformly routing anonymous traffic between them over the one or the other network they both are connected to and making this mass transit change-over if signalled, but
   keeps track, within this anonymous mass transit, of any individual communications connection subject to '902 control, and makes it being changed-over if so signalled—but without thereby enforcing any other communications connection to also change-over.
(d′) The improvement over prior art described by the inventive '902 concept “Practicable on any line- and any packet-switching network” is illustrated by the metaphor “from self-fertilization to cross-fertilization”. This metaphor for said inventive concept conveys that the claimed '902 invention
   does not afford itself the comfort to be applicable only on a packet-switching network, which is capable of controlling the line-switching network (=“self-fertilization”). This were the case e.g. in an ISDN seen as a packet-switching network and a separate line-switching network—a view against any pertinent ordinary skill, which always sees the ISDN as a single line-switching network (though it may provide to its users some packet-switching functions for data transfer). Consequently the '902 specification explicitly excludes the use of an ISDN's D-channel as its data channel. '902 at col. 5, II. 2-3.
   but is subject to the important independent limitation that it may be practiced by any packet-switching network, which to this end may pair with any line-switching network (=cross-fertilization).

In biology this distinguishes species of low adaptability to changing environments of biological life from species of high adaptability. The '902 invention then is a data transfer technique of high adaptability to changing environments of telecommunications techniques—as its follow-up US patents confirm.
(X) The notion/meaning of the term “inventive concept as of (I)-(IX) is crucial for the succeeding seemingly more abstract elaborations on this term. I.e.: The four '902 inventive concepts of (II) used for these introductory explanations are both: “elementary” and “compound” inventive binary concepts—and hence representative for the type of concepts ubiquitously encountered in patent specifications' and their claims' wordings. These are to be separated from elementary and compound non-inventive binary concepts of claimed inventions. Therefore, the latter kind of concepts is discussed next, i.e. without limiting them to be inventive. Thereby it is always up to the user to decide whether a specific disclosed pair <legal fact, technical fact> is an inventive concept or not.

### II.3.2—Increasing the Preciseness of this Notion of “Concept” by Mathematical Notation

As shown in II.3.1, the use of inventive concepts by a patent practitioner has absolutely nothing to do with mathematics. I.e., the below (trivial) mathematical definitions of the notion of concept and related notions are provided for being clear/precise and excluding misunderstandings—as to “model based” inventions tested under §112 for being met by their specifications, in spite of their being of “non-MoT” type, i.e. “purely mental”. They provide a solid scientific fundament for
completely/precisely/clearly modeling patent laws' and Highest Court patent precedents' rationales, just as for
testing a claimed invention's meeting the rationales alias requirements of patent laws/precedents, and only this.

The notion of “concept” is as easily to use, as swimming or driving a bike—once learned, what is an alike exercise. I.e., once acquainted to it, the notion of “concept” turns out to be really trivial.

A claimed invention alias TT.0 is described by a set of “inventive concepts, {in-C}” being a subset of the set of all concepts “{C}^{PTR}” useful in testing a PTR, the “^{PTR}” often being omitted. A declarative/instantiated C has a “domain, dC or d(C)” as area of definition and several/one “universe/s, U(C)” of unique mapping/s M of C's domain onto C's “value set, vC or v(C)”, the latter being U(C)::={(x, y)|x∈dC [symbol] y=M(x)∈vC}. In IT terms: A C is a (often parameterized) “class” declaration or an “instantiation” thereof, both input by the user—when what is left to it, too. A C is called “binary” iff vC={T, F}. In dealing with patent law/precedents, only binary concepts are needed.

A C mirrors a property of an element^{II.1} in that it provides the basis for defining the predicate representing this property. I.e.: Its “mirror predicate, C” is defined by its “truth set, TS(C)”::={x∈dC|M(x)=T}⊂dC^{1):9)1}. Such a C and its C are defined by determining dC and its TS(C). Thereby only resp. TS really counts, i.e. its dC complement comprises “anything else”. For a compound such predicate, i.e. for a conjunction C [symbol] C′, holds: TS(C [symbol] C′)=TS(C)×TS(C′)⊂dC×dC′—which is used in disaggregating alias refining alias separating the concerns of compound Cs^{II.3.3}—and C completely determines C, thus making the under stroke superfluous (unless needed for clarity).

Using these terms/notions, the above ants-relation is defined to hold between two binary C′ and C″ iff TS(C′)=TS(C″). This usually is denoted as “C′ anticipates C″” abbr. by “C′ ants C″”. Its symmetry is somewhat misleading, as both Cs come into existence at different points in time, and only the earlier C may ant the later C.

In advanced IT, independent inventive concepts “BID-in-Cs” are the only known means for simply precisely describing—in detail and as a whole—a claimed invention and its elements, as the Supreme Court requested and the CAFC asked for by its “aspects”. I.e., all are in full agreement about how to describe model based inventions.

{C}^{PTR} comprises 3 sub sets, {o-C}∪{BAD-C}∪{BID-C}”, the 0-/BAD-/BID-identifying 3 non-unique¹⁾ KRs of TT.0, i.e. 3 levels of abstraction alias separations of concern (see II.4), of describing the claimed invention alias TT.0. oCs are explained by (I)-(X) in II.3.1, BAD-Cs and BID-Cs later. All three are not necessarily unique^{1):D3}.

Any in-C of TT.0, no matter of what KR of TT.0, is defined to be a le-C including a cr-C, whereby the “legal-C, le-C” models in-C as “legal”-fact of TT.0 legally justifying that the “creative-C, cr-C” is in-C's “technical”—alias “subject matter”-fact of TT.0²⁾. Colloquially, again: A claimed invention's inventive concept in-C, as used here for modeling patent law/precedents, is a legal concept including a creative concept, both concepts disclosed ex- or implicitly by its patent—up to 35 USC §§112/102/102/101 and the above quoted Highest Courts patent precedents.

Hence, any BID-in-C comprises two domains—of its d(BID-le-C) and d(BID-cr-C), with a truth set of its own. Thereby any d(BID-le-C) eventually supports legal argument chains from doc.CT referring to it, comprising a technical fact as to doc.i. As any BID-in-C is tied to exactly one X.0.n, 1≦n≦N, TS(d(BID-le-C)) and TS(d(BID-cr-C)) is the same for all instantiations of BID-in-C, i.e. for all such instantiations of BID-in-C. A B-in-C, used for describing a property of an X.i.n, i>0, evaluates to T iff both its arguments evaluate to T. Evidently all B-in-Cs used in describing TT.0 evaluate to T.

Thus, modeling the refined claim construction as requested by the Supreme Court in its interpretation of these 4 sections of 35 USC shows that a technical fact only exists as implied by a legal fact, i.e. the notion “inventive concept” stands for a legal notion embodying a technical notion. The Supreme Court and CAFC in Markman hence denoted claim construction as a “mongrel”. Colloquially speaking this means: Any question about an in-C of a claimed invention is a “legal question”, which always implies a question as to the subject matter disclosed by its patent. Consequently, claim construction deals with both kinds of questions—though only with those technical questions implied by the resp. legal questions. This evidently may require an iterative process of clarifying an in-C.

Slightly other facets of the just said are: An “inventive concept”—as Mayo requests to be used in claiming an invention—is nothing else but a lawful disclosure (=B-le-C) of a simple technical statement (=B-cr-C) describing an inventive property X of an element X of this claimed invention. Thereby patent precedents get along
with simple such statements, having the form: “X has (this inventive) property X”. Here, any such statement may put such as to be solely true or false and then is called a “binary inventive concept”, as shown by II.3.3, whereby
any element's binary compound concept usually is straightforward disaggregatable into a conjunction of binary elementary concepts^{1):9)}, each one being next-to-trivial. This disaggregation is indispensable for warranting that the elements' inventive concepts meet the requirements explicitly and implicitly stated for them by §112 and its interpretation by the Highest Courts: to be disclosed by its specification so clear, definitive, and enabling that it is possible to warrant by (independent and nonequivalent ones of) them the claimed invention's novelty, nonobviousness, not being only a natural law, or idempotent, or preemptive as it is only an abstract idea.

Thus, the notion “inventive concept”, as introduced by the Supreme Court, represents a legal fact embodying a technical fact. For a claimed invention—and the inventive concepts it consists of—this notion enables 10 tests greatly supporting verifying their above 10 properties, here named its “refined claim construction”. It takes claim construction to a much higher level of development than the classical claim construction is on. This scientifically much higher level of patent precedents is indispensable for enabling patent precedents' consistency and predictability also for model-based claimed inventions—being typical for all emerging technologies but also for some recently established ones—i.e. for eliminating the troubles caused by applying classical claim construction to them.

### II.3.3—Inventive Concepts' Impacts on Claim Construction

Much of Section II is presented—in a slightly different, easier to read, but less instructive wording—in an amicus brief to the CAFC in its LBC case. This brief's elaborations on the significant impacts of inventive concepts on the notion of claim construction are here included, next, due to an important reason: The explanation of these impacts shows clearly how a claimed invention's inventive concepts overcome the problems, which recently arose in the above quoted Highest Courts' decisions with model based inventions when performing the classical claim construction for them.

This inclusion introduces some redundancies into this patent application's specification—which are not eliminated as they may be helpful for grasping the message conveyed by the claimed inventions of this patent (application), heralding the advent of an emerging patent technology, paving the way for the advent of a Mathematical Innovation Theory of even more fundamental social/economic significance, still requiring some time.

### II.3.3.1—The Necessity of a Refined Claim Construction, as Signaled by the Invitation of LBC Amicus Briefs

The two main questions, raised by the CAFC in its invitation of amicus briefs in the LBC case, are to be regarded in the light of the Supreme Courts' KSR/Bilski/Mayo/Myriad decisions. Thus spotlighting them, they may be rephrased as
A. Should the CAFC overrule its Cybor decision13 if so, due to which new and/or today improved understandings of what “aspects” in claim construction
B. Should the CAFC afford deference to any “aspect” of a District Court's claim construction—if so, to which “aspects”
   This shows that the CAFC is about to identify more firm ground for claim construction—by its such new “aspects”.

Before going into details, first the existence of this shift of a US patent law paradigm is briefly reassessed.
By its KSR/Bilski/Mayo/Myriad line of unanimous decisions the Supreme Court requested this development—adjusting patent precedents to the needs of emerging technologies, to using the potentials of advanced IT, and to following the known pattern of development of any natural science. Hence, as a first step to this end, it introduced into claiming an invention its “inventive concepts”, identifying therein the elementary building blocks of its creativity/inventivity—as the basis for checking its patentability and patent-eligibility. The driving force, in this line of decisions of the Supreme Court, is its responsibility to warrant that the economic requirements of the US society, as stated by 35 USC, are met by the US patent system also in the future by patenting model based (i.e. intangible subject matter based) inventions, as typical for emerging technologies.
The CAFC is constitutionally responsible for developing the US patent precedents within the framework of 35 USC and these Supreme Court decisions. Yet it shows uncertainties about its key-words/-notions, such as “inventive concept”, “abstract idea”, “preemption”. In this invitation of amicus briefs the CAFC implicitly addresses them by asking for “aspects” of the refined claim construction within this framework—by asking for a more complete, precise, and unmistakable future claim construction.

The legalistic driver of these Highest Courts' initiatives was that they both got aware of shortcomings of the classical claim construction—as determined by the Markman and Philips landmark decisions—for claimed inventions dealing with emerging technologies. Indeed, as proven by the Supreme Court in particular in its Bilski/Mayo decisions and by the CAFC in its Myriad/CLS decisions, applying just the classical claim construction for a model based (as emerging technology) claimed invention, does not yet enable recognizing that
all its creative properties of all its elements (=all its “inventive concepts”) are lawfully disclosed as required by §112, i.e. exactly as they are used in its later tests under §§102/103/101, and
these hitherto identified/checked creative properties of all its elements do render its claim as non-preemptive and already the patent-eligible ones of them achieve the claimed invention's patentability under §§102/103.

The Supreme Court hence clearly requested to remove this deficiency of classical claim construction. This implies defining a “refined claim construction”—and the CAFC is about to clarify what it is going to be in detail.

These deficiencies of the classical claim construction are due to two peculiar features of all emerging technology inventions: Their and their problems' descriptions, in the patent specification, are always i) “model-based” and often ii) implemented as and/or by a “software system”. Both these features require a preciseness of consideration—also by the person of ordinary skill and creativity (KSR/Bilski/Myriad/Mayo/CLS)—never needed for classical “machine or transformation” type inventions. It is embodied by using inventive concepts.

Feature i) encourages sloppiness in drafting and/or interpreting in particular claims (but also their patents' specifications), as the model as such underlying a claimed invention often is not clearly understood^{5),II.3.3} (a counterexample of a more mature model is that underlying telecommunications⁶⁾). Then this model based claimed invention—notionally always to be described as an application on top of its model and using it, e.g. a synthetic DNA molecule^{II.3.1(VIII)}, this model as such comprising a conglomerate of patent-ineligible natural laws and/or abstract ideas thereof, which is irrelevant here—is described/interpreted in a way mixing it up with this model, on which it inevitably is based. This absurdly makes it part of patents granted.

Feature ii) is another source of uncertainty, as a claim on a software-implemented invention is a claim on a whole set of inventive methods/apparatus, established by the set of all its possible implementations. These may technically differ so dramatically from each other that the question arises, whether the claimed invention is “not an abstract idea only” of an invention, in that its inventor has only vaguely delimited the boundaries of its applicability (see the amicus brief in the CLS case, www.fstp-proiect.com). This is the case if and only if its specification, including its claim's wording, has been drafted such that it does not exclude that the scope of protection of the claimed invention is “preemptive”—as shown in Sections II.5.2 and III.1.

Mathematical Knowledge Representation (KR) research, focused on this framework set by the Supreme Court, shows that it actually already took patent precedents to a level of development unimaginable prior to this line of decisions. I.e., that these initially unclear but now fundamental notions actually are absolutely crucial for avoiding troubles for future patent precedents granting patent protection to “model based” inventions. This line of Supreme Court decisions clearly unfolded, right from its beginning, trail blazing potentials towards settling this problem of current claim construction for claimed inventions in emerging technologies.

The result of this advanced IT research: There are two insights as to defining a claimed invention's refined claim construction according to 35 USC 112 such that it enables its test under 35 USC §§102/103/101 as interpreted by these 3 USSC's decisions as to its patentability and patent-eligibility. They may be put as follows:
The classical claim construction for a claimed invention is to be expanded—to a refined claim construction—by appending to any one of the elements^{II.1} of the claim's wording a list of the claimed invention's inventive concepts, the conjunction of the mirror predicates^{II.3.2} of which describes this element's invented property.
For a claimed invention's so refined claim construction holds: It has 10 testable aspects, all of which it owns iff it is patentable and patent-eligible, i.e. iff it meets all requirements stated by these 4 sections of 35 USC up to this line of their Supreme Court interpretation. All these 10 tests are partially or completely unknown to classical claim construction. It seems extremely unlikely that the above notion of a claimed invention's inventive concepts and its refined claim construction, all these tests are depending on, may be replaced by an alternative system of terms/notions consistent to the established patent law/precedents.

This necessary and sufficient testable criterion for a claimed invention, to be patentable and patent-eligible—iff it is owning these 10 aspects—induced developing “patent technology”: These 10 aspects' tests are e.g. capable of automatically guiding their users through them, in explorative and in affirmative (then even real-time) execution mode. This criterion and its refined claim construction provide the resilient fundament of future patent precedents—as induced by the Highest Courts—consistent and predictable also over all model based inventions.

### II.3.3.2—The Advantages Provided by the Refined Claim Construction

The Supreme Court's decisions clearly request that patent precedents cater to needs of the sectors of economy based on innovations, i.e. on emerging technologies. In Mayo it requests warranting, as part of testing under 35 USC §101 a claimed invention using a “natural law”, that—if it is patented—) is not preemptive, i.e. not only an abstract idea⁵⁾, and ) embodies an amount of patent-eligible creativity deserving being patented^{II.5}. Thereby the latter is to be justified by at least one inventive and patent-eligible concept, i.e. one or several such concepts.

I.e.: The Mayo decision implies that, in such a claimed invention's test under 35 USC §§102/103/101,10 aspects are to be checked hitherto partially ignored or unknown—in the future hence to be comprised by a refined claim construction for it according to §112. It thus requests to make sure that, of a model-based claimed invention,
all its inventive concepts are identified, though quantifying its creativity only by non-natural-law inventive concepts—whereby the Supreme Court requested in KSR already considering also the potential idempotence of the so identified amount of creativity—and it is nonpreemptive (more precisely: the scope of its claim),
while in Bilski it requested already that also a model based claimed invention is not only an abstract idea of it by not identifying its pragmatics, i.e. not becoming concrete about the problem(s) it is designed to solve.

In other words, this line of Supreme Court decisions requests to refine the classical §112 claim construction for a claimed invention by identifying and checking the lawful disclosures of all its inventive concepts impacting on its test under §§102/103/101. The so refined claim construction's “aspects”, the CAFC asks for, are these impacts of these inventive concepts on its tests under §§102/103/101.

Thus, a claimed invention's refined claim construction has 10 “aspects”, depending on its inventive concepts' selections/definitions and in general not unique, for which holds: The claimed invention is patentable and patent-eligible—i.e. it meets all requirements stated by these 4 §§of 35 USC to be met by it—iff it “owns” all 10 aspects alias they all are true. These 10 “aspects” of a refined claim construction are:
§112, “well-definedness of the inventive concepts”, i.e. their being 1) disaggregated into elementary ones, and their uses in §§102/103/102 are disclosed 2) lawfully, 3) definitively, and 4) enablingly
§§102/103, “novelty/nonobviousness of the invention”, i.e. its 7) sufficient amount of creativity/inventivity, after having assessed their 5) independence, and 6) nonequivalence;
§101, “patent-eligibility of the invention”, i.e. its not being 8) only a natural law, or 9) idempotent, or 10) only an abstract idea alias its claim being preemptive.

Thereby holds for these 10 aspects, the CAFC asks for: A classical claim construction ignores in its aspects 2)-4) their “§§102/103/101 aspects” (of the claimed invention's inventive concepts), i.e. the aspects 5)-10)—while a refined claim construction warrants that its aspects 2)-4) additionally take into account the limitations imposed on its inventive concepts by its test under §§102/103/101, i.e. the aspects 5)-10. Warranting this is possible iff also aspect 1) is true, i.e. all its inventive concepts are disaggregated into elementary ones.

In total, there are very practical advantages for the patent precedents coming along with using, of a claimed invention, its inventive concepts and their implied refined claim construction. The patent technology developed on this basis, induced by the Highest Courts' patent precedents—and advanced IT—enables:
to break down the 4 compound tests of a claimed invention under 35 USC §§112, 102, 103, 101 for determining its patentability and patent-eligibility—these compound tests are probably not capable of automatically guiding their user through their executions, and even if, they would prompt it to reply questions that simply have no answers—into much more elementary 10 FSTP tests, which in total are equivalent to the 4 compound tests, i.e. for which KR shows to hold: A claimed invention passes the 10 FSTP tests iff there is a legal argument chain proving that the claimed invention passes the 4 compound tests, which implies
that it is, beyond any doubt—even if it is model based, if it only passes them—nonobvious and nonidempotent and not only an abstract idea (=nonpreemptive), and enables
automatically guiding its user through any NANO Test in explorative testing mode and automatically delivering, in affirmative testing mode, this legal argument chain completely in dialog-real-time upon the user's query for it—if requested even all existing such legal argument chains (see III and IV).

### II.4—Disaggregating Compound Inventive Concepts⁷⁾ for the Refined Claim Construction

There are two different and complementary guidelines for disaggregating compound inventive concepts into elementary ones. They deal with “level of abstraction”/“grain of mental resolution” achieved by this disaggregation resp. with its “degree of separation of concerns”/“degree of elementarity”. Both phenomena are effective in any disaggregation.

For simplicity, the next paragraphs leave away Ie-Cs and talk only about the inventive concepts' cr-Cs.
The “level of abstraction” of inventive concepts, i.e. their “grain of mental resolution”. First of all: The higher the level of abstraction is of a description, the coarser is its grain of mental resolution of its—level-independent—elements'/Xes' property/attribute/predicate, i.e. Xes or cr-C, which they qualify. The prefix “o/BAD/BED⁸⁾/BID” of an X.0.n or of a cr-C identifies¹⁾ the “level of abstraction”/“grain of mental resolution” of some “knowledge representation, KR” using this X.0.n or a cr-C of X.0.n (ex- or implicitly^{1):7}): “original, o”, “binary [symbol] aggregated disclosed, BAD38 ⁸⁾, [symbol] binary [symbol] independent [symbol] disclosed, BID”^{1):9)1}, “binary [symbol] elementary [symbol] disclosed, BED”⁸⁾. Thereby, any level's such use must be justified by a set of “marked-up items, MUI^{m}.i” of information, 1≦m≦Mⁱ, in doc.i^{1):5)b.D3}. In any KR an AC^{II.2}∈ps+pa may ant some or all cr-Cs in this KR.

Determining only the “compound” BAD-cr-Cs—and their original o-cr-Cs^{1):D3/N3}—is often misleading^{1):4)g.(5-8),7)c}. But, the classical way of facts determination considers only TT.0's o-cr-C, i.e. is fully based on only the o-level, although it—and even the BAD-level—of abstraction often are deficient^{1):4)g,(5-8),7)} as too high: I.e., their grains of notional resolutions are simply not fine enough for recognizing fundamental issues, such as the independency of concepts, e.g. of patent-eligible or non-patent-eligible ones. Noticing this deficiency, in particular the US Supreme Court's line of KSR/Bilski/Mayo/Myriad decisions asks for a more refined facts determination^{4),5)}, I.e., often the BED-cr-Cs—actually at least the BID-cr-Cs, if not even more carefully tested cr-Cs—are indispensable, of which the o- and BAD-cr-Cs are “composed” alias “compounds”^{1):N5i),9)1}. Only thus tested BED-cr-Cs are suitable for dependably meeting Highest Courts' demands as to analyzing a model based claimed invention by means of them—as seen from KR, i.e. the respective rationality^{1);*)}, point of view^{III.,1):4)g,(5-8}.

Thus, while the BAD- and o-levels are needed for a claimed inventions' “structural analysis”—i.e. their actually invented elements resp. their compound properties/attributes/predicates^{II.2.II)}—the refined claim construction's checks of aspects 2)-9)^{II.3.2} must involve the BED/BID-cr-Cs' level of abstraction and the even finer grains of notional resolution⁸⁾. Otherwise the Supreme Courts above requests are not obeyed.
The “separation of concerns” by inventive concepts and the “elementarity” of both: While the above qualities of descriptions (on higher and lower levels of abstraction) are known from everyday life, the supporting of thinking by “separation of concerns” is not commonly known—though it is around since 40+ years—and thus needs some explanation, provided next, just as its relation to final such separations alias elementary concerns.

Thereby we shall see: The more a claimed invention is represented by elementary inventive concepts, the higher is its separation of concerns, i.e. the likelyhood that its thereby refinable concerns also are elementary. Following this sophisticated insight, a prefix “o/BAD/BED/BID”⁸—of an X.0.n or of its X.0.n or of a cr-C of this X.0.n—does not only identify, as above, some unspecific “level of abstraction“/”grain of mental resolution” of some KR using them (ex- or implicitly^{1):7)}), but it also indicates the degree of “separation of concerns” of the claimed invention achievable on these levels of abstraction. Thereby the process of “separation of concerns” of a claimed invention is not a synonym of the process of “disaggregating its inventive concepts”, but it is the driver of the latter, until all its elementary inventive concepts—describing the claimed invention—enable describing its concerns as completely separated from each other, here called “elementary concerns” (in their conjunction being equal to the original compound concerns). In patent precedents, of a claimed invention, the compound concerns considered here are the above 4 §§of 35 USC, and the elementary concerns of its refined claim construction are exactly the 10 aspects of it, the CAFC is asking for.

Indeed, such dualities of concepts and concerns exist and are in practical use since long time already—without being noticed this way. Since centuries e.g. Mathematics/Physics/Engineering know the need of unquestionable bases for making precise statements about systems they deal with: “Coordinates” there serve as such a basis for this need of separation of its concerns—often being the same: This system's location(s) put in these coordinates alias concepts, and e.g. its impulse(s) and/or energy and/or volume and/or . . . being its concerns.

Since the 1970s' IT, Data Base Modelling techniques use the notion of concepts, much more powerful than that of coordinates, later also Artificial Intelligence (Al), Natural Language (NL), Description Logic (DL), KR, . . . , here jointly called “advanced IT”. The term/notion of concept survived all these changes of names in advanced IT research, and today is fundamental therein as ever. A similar duality of the notions “concepts” and “concerns”, known by Linguistics also since ever and called there “semantics” qualified by “pragmatics”, is here too simple.

Concepts stayed evergreen due to their separation of concerns embodied by requirement statements by disaggregating the compound concepts modelling them into elementary concepts. “Separation of concerns” was first discovered, also in the 1970s, as a key issue in system design by David Parnas, one of the godfathers of SW-System-Design technique. In an IT system design, since then, a compound requirement/concept must be disaggregated into its elementary concepts, thus not only reducing its level of abstraction but also enabling separating the system's concerns: As elementary concepts are next to trivial elementary concepts are alike.

The contrary happens in a man's psyche: For human intelligence compound concepts, i.e. high levels of abstraction, are intuitive and hence ubiquitous in NL, e.g. in wordings of patent claims. Yet for consistency and predictability in patent precedents they are too error-prone—proven ten thousands of times at incredible cost in any kind of system design. Strangely enough, all these many disasters didn't affect the congenital mind setting of most men lacking this particular IT education, e.g. of decision makers rejecting such inconvenient insights.

Not so the Supreme Court. With its Mayo decision it builds on this only known in general successful technique of “separation of concerns”—underlying Mathematics/Physics/IT^{1):*)}—by explicitly requesting to use this notion of inventive concept for describing a claimed invention's creativity.

Much of the currently sometimes irritating and unpredictable courts' decisions as to testing a claimed invention by the above 4 §§of 35 USC is due to the attempt to become precise about the relations of the meanings of these four sections to the meanings of its terms (=compound concepts), without disaggregating them, first, into their inventive binary elementary concepts, thus first separating its 10 elementary concerns alias aspects (see above). Advanced IT¹⁾ knows that such attempts must fail to achieve consistency.

The question then arising is, how far such refinements of the “grain of mental resolution”—driven by and/or striving for complete “separation of concerns”—may and/or must be performed.

As to “may”: The barrier for endlessly performing refinements is that evidently no practical patent specification discloses infinitely many inventive concepts over pertinent ordinary skill (technically not being “equivalent”). Thus, in any patent, there is only a finite set of non-disaggregatable alias elementary inventive concepts—and aspect 1) assesses that any one of its compound inventive concepts is logically equivalent to a conjunction of them.

As to “must”: Meeting this disaggregation/separation of issues requirement does not imply there is a need to leave, in legal arguing, the style of communications using natural language (though that of a person of pertinent ordinary skill)—but it requires (and hence warrants) that such argument chains are easily recognizable as right or wrong. There also is no need to drive this refinement to its ultimate: As soon as all intricacies potentially introduced by using nonelementary concepts are excluded, this refinement process may be stopped.

The last paragraphs are just plain analytic philosophy—i.e. represent thinking ground laying for AI, here applied to patent jurisdiction. They yet may help every “patent practitioner”: For showing them that the notions of inventive concepts and of refined claim constructions, induced by the Highest Courts, are powerful enough to contribute to stimulating
all kinds of innovation activities in all areas of societies for unfolding and/or warranting their wealth,
developing patent precedents' needs as to improving its efficiency and predictability, just as to regaining its consistency, in particular as to emerging technologies, and in particular
developing further going advanced IT for Innovation Expert Systems, as they model the working of our brain as to its operations in “rationality mode”,
   as does the Supreme Court when unanimously insisting in proceeding this way by its above quoted decisions.

### 11.5—The Semantics of the Refined Claim Construction's 10 “Aspects”

### II.5.1—The Necessity of the Supreme Court's Notions in Interpreting 35 USC §§112/102/103/101

Much of the currently sometimes irritating courts' decisions—as to testing a claimed invention via its classical claim construction under these 4 §§of 35 USC—is due to trying to become clear about the relations of the meanings of these four sections of 35 USC to the meanings of the invention's features, which a particular claim protects, i.e. of the so-called “claimed invention”. These decisions strive for this clarity without first clarifying what the claimed invention's inventive concepts are, at all, and disaggregating them into their elementary inventive concepts^{II.4}, more concisely: without also first separating its various elementary concerns^{II.4}—although only on this low level of abstraction, i.e. by this fine grain of mental resolution^{II.4}, the here interesting 10 elementary concerns/aspects^{II.3.2} of the claimed invention and its inventive concepts are rationally identifiable/recognizable/determinable.

I.o.w. and like indicated above already: By the initially usually compound/coarse inventive concepts, i.e. on their high level of abstraction, i.e. by this low level of mental resolution, clarity is not achievable. It namely implies excluding separation/isolation of concerns: Its concerns are not definable as there not yet notionally existing, and hence also not its interrelations to the above 4 §§of 35 USC. But logically this is indispensable for making rationally justifiable statements about them. In this way hence also no consistency or predictability of patent precedents is achievable. And the situation is even worse, if no inventive concepts at all are determined for a claimed invention, yet—as it occurs when testing the claimed invention under the 4 §§of 35 USC via its classical claim construction.

By contrast, the use of the Mayo decision's inventive concepts and the claimed invention's implied refined claim construction enable—as they lead to the claimed invention's elementary separated/isolated concerns, then notionally existing and hence clearly definable—becoming also clear about the latter's 10 aspects^{II.3.3.2}, asked for by the CAFC. This, in turn, enables regaining the consistency in patent precedents, as required for enabling the community of patent practitioners to recognizing that patent interpretation by the person of pose, an expert, an Examiner, a lawyer, and a court is the same and hence highly predictable. As a legal system ought to be.

The CAFC's suggestion as to screening, within the Supreme Court defined^{II.3.3} framework, a claimed invention's classical claim construction for its thus implied new aspects^{II.3.3.1} (in the context of affording deference) means first identifying its new aspects by means of the claimed invention's inventive concepts, implying a refined claim construction. Thus, this suggestion is a consequential step of making operational this Supreme Court's framework.

### II.5.2—The 10 Aspects' Semantics and the Sufficiency of these Highest Courts Induced Notions

For a claimed invention—representing and described by its inventive concepts—i.e. for the invented technical teaching, TT.0, the list (i)-(iv) of the 10 aspects of its refined claim construction explains, how any aspect is related to at least one of the requirements stated by the above 4 §§of 35 USC. The totality of these 4 sections' requirements corresponds to exactly its refined claim construction's 10 aspects, the CAFC asked for^{II.3.3.1}—and whether it owns them is checked by the abstract 10 FSTP Tests. The here claimed 30 inventions are applications of them.

The explanation of any one of these aspects, here in Section II, only colloquially outlines its resp. specific semantics, as today usual in patent business communications about legal issues. The definition of the semantics of such an in-C is always provided by the user of the IES, but “structurally” it takes place under IES control, and hence in so far precisely as according to its inherent structural mathematical description—as explained in Sections III/IV.

Thus, it is evident that—after a refined claim construction for a claimed invention has been completed—the confirmation by a pertinent expert may be needed for any one of its 10 aspects, i.e. the semantics definition of its 10 concerns, (i)-(iv) show that the set of all requirements stated by the 4 §§(to be met by TT.0's concerns for its being patentable and patent-eligible) are met iff these 10 aspects/concerns hold for TT.0 and its inventive concepts.
(i) The aspect 1 of the refined claim construction represents its concern, whether—in some KR of the claimed invention—its compound inventive concepts in this KR are disaggregated into BED-in-Cs of this KR.

Clarifying this concern is indispensable for enabling the decision, whether the refined claim construction—and hence the claimed invention—meets the various requirements stated by the above 4 §§of 35 USC for it to be patentable and patent-eligible or not. As of above, this statement ought to be confirmed by an expert, as to recognizing/defining the claimed invention's compound/elementary inventive concepts and their equivalence.

For the other 9 aspects, this remark as to the need of an expert need not be repeated.
(ii) The aspects 2, 3, 4 of the refined claim construction represent its concerns, whether there are “well defined” BED-in-Cs, determined as to aspect 1, that may be used in (iii) and (iv), and if so which.

“Well defined” is defined to mean that §112 and the resp. Highest Courts' precedents show which of these BED inventive concepts, BED-in-Cs, are disclosed in the KR as of (i)
lawfully (aspect 2), i.e. according to the Markman/Phillips decisions, but now testing TT.0 as a whole under §112—i.e. considering the inventive concepts' definitions also as to the aspects 3-10—thus establishing the inventive concepts as “legal facts” to be lawfully described as to all these aspects by the specification, and which in turn comprise their individual “technical facts”, these clearly disclosed therein for the pose.
definitely (aspect 3), complementing the Phillips decision as to §§112.6 by the CAFC's Intuit decision, and
enablingly (aspect 4) as to the solution of the problem set out by the specification to be solved by the claimed invention, i.e. not just somehow—as classically seen—but specifically as enabling this particular solution alias claimed invention (needed only for BED-in-Cs of which implementing is unknown by skill),
   whereby aspects 2-10 may exert substantial feedback on the refined claim construction as to the selection of a suitable KR for them, e.g. the selection of a suitable subset of BID-in-Cs from the set of all its BED-in-Cs. This applies in particular to the aspects 5-10, not at all taken into account by the classical claim construction.

Note that (ii) in principle fully answers the CAFC's question A. (and implies also B.). But understanding (ii) requires understanding the aspects 5-10—which represent the kernel of the Supreme Court's KSR/Bilski/Mayo/Myriad line of decisions—and hence are also elaborated on, next.
(iii) The aspects 5, 6, 7 of the refined claim construction represent its concerns, whether the claimed invention is indicated novel and nonobvious. Assuming its refined claim construction's inventive concepts have passed the tests for aspects 1-4—which evidently may imply a reiteration of (iii)—these 3 aspects are concerned with TT.0's minimal creativity over all these BED-in-Cs, ignoring its “pragmatics” (if there is any, dealt with in (iv)).

Aspect 5 is concerned with the independency and aspect 6 with the non-equivalence of the BED-in-Cs selected as BID-in-Cs for aspect 7, checking TT.0's novelty and nonobviousness using the “NANO Test” for both questions (classically understood as being 2 tests). These aspects are discussed earlier¹⁾ and skipped here.

Note: In (iii)-(iv) it is more convenient to talk of the claimed invention's tests instead—more accurately—of its refined claim construction's aspects.
(iv) The aspects 8, 9, 10 of the refined claim construction represent its concerns, whether its BID-in-Cs (having passed the tests for aspects 1-7) are representing ) nothing but one or several not-patent-eligible inventive concepts representing natural laws (aspect 8), or—potentially besides these—) nothing but one or several patent-eligible inventive concepts representing in total an idempotent novelty (aspect 9), or ) a novelty representing only an abstract idea about its claimed invention (aspect 10). If one of these aspects is true, TT.0 is not patent-eligible—as implied by the above line of Supreme Court's decisions, as explained next.

These 3 aspects discussed in (iv), just as that of (iii), completely exceed the notion of the classical claim Construction—hence the refined claim construction. By the Mayo decision the Supreme Court declared them legally essential. Hence they are law. It is inherently applicable to any “model based” claimed invention, comprising those from emerging technologies. Consequentially, for model based claimed inventions patent-(non)eligibility has recently come up as a central issue—in advanced IT, business technology, life science technology, nano technology. Examples are the recent Highest Courts' decisions in e.g. the cases KSR/Bilski/Mayo/Myriad/CLS/lntuit/LBC/ . . . .

This requires cracking these 3 aspects: By breaking them down from their compound concerns in the inventive concepts' o-KR into elementary concerns in some BID-KR of the inventive concepts of the TT.0.

Nothing of this subtlety of the objective interrelations between the patent law and model based inventions could ever have been stated by patent precedents prior to the Supreme Court's KSR/Bilski/Mayo/Myriad line of decisions. Due to the above groundbreaking insights into these interrelations—inviting further development—already now a canonical way comprising 10 tests is disclosed here, of assessing that a claimed invention's refined claim construction meets all requirements stated for it by the above 35 USC §§112/102/103/101. Passing these 10 tests by a claimed invention's refined claim construction is necessary and sufficient for its owning these 10 aspects. These tests are even partially automated and thus represent a large step forward on the way of developing a powerful “patent technology”, at least an amazingly powerful “Innovation Expert System”.

Checking these 3 aspects of (iv) for a claimed invention as to its §101 compliance prior to performing the tests as to its aspects 1-7 from (i)-(iii) with it—i.e. prior to checking its BID-cr-Cs—is logically impossible: These 7 tests first provide the notionally and logically consistent basis for these final 3 checks of a claimed invention's refined claim construction, as clearly requested by the Mayo decision. I.e.: Without the necessity—thus being unquestionable—to determine these legal and technical facts of a claimed invention, first, there is no firm ground on which to base patent-eligibility decisions consistent over the whole range of claimed inventions on top of model based and/or computer-implemented systems. In other and summarizing words: Checking for a claimed invention whether it passes being tested for the aspects 8)-10) is meaningful only after its refined claim construction has passed the tests for aspects 1)-7) in (i)-(iii), whereby the tests for its aspects 8)-10) may impact the set of BID-in-Cs of 1 )-7)—yet this TT.0's creative height over RS being invariant over all such sets^{1):Theorems I/II}.

To this end, first the terms/notions must be clarified, the aspects 8)-10) deal with. The notion of a claimed invention “not being a natural law”—comprising laws of mathematics, physics, . . . as being natural laws—denotes an aspect intuitively understood and seemingly needs no further elaborations, currently at least. The term of its “not being an abstract idea” and this key term's sibling term of its “not being preemptive” identifies a much more sophisticated aspect/concern of a claimed invention's refined claim construction, requiring the following elaborations.

The most spectacular of the groundbreaking terms/notions of this line of the Supreme Court decisions, the (non)preemptivity of a claimed invention's claim, feels to be simple, but taken meticulously turns out to be intriguing—why the CAFC wanted it to be commented on, being one of the new aspects of the refined claim construction. Putting it “advanced IT like”, the definition of the notion of the Supreme Court's term “(non)preemptive” is:
TT.0 is preemptive iff the scope of patent protection of the TT.0's refined claim construction comprises a TT* solving a whatever problem P*, with TT*<^{TT} TT.0 or P*>^{P} P.0,
   P.0 being the problem set out for solution by TT.0's specification, and “<^{TT}/”>^{PII} being the “less/more in-C-limited than” relations^{9),10),13)} between TTs resp. Ps in KR* resp. in KR⁰, i.e. the mod(KR bijections*) being skipped.

While nothing is wrong with this notion of (non)preemptivity, the way it is defined does not meet the pragmatic needs of patent precedents—as it is misleading, e.g. when ignoring the “refined”, as shown in i.)-iii.), next.

Assuming the inventor is a person of also ordinary ambition (additionally to ordinary skill and ordinary creativity, abbr. “posca”) implies that it ex- or implicitly discloses, in the patent's specification of TT.0, all the problems it knows to be solved by its invention and which it rightfully is entitled (by 35 USC) to consider as being comprised by the scope of TT.0's classical claim construction and hence by the monopoly defined by this claim. But then intricacies arise necessitating supporting this definition of nonpreemptivity—also referring to unknown TT*s and hence not being constructive—by a constructive definition, which avoids such confusion, as shown by i.)-iii.).
i.) Seen from the lawmaker's point of view, although there is no rationale for extending a patent owner's patent monopoly on its invention to a solution of a problem⁴⁾ not explicitly disclosed in the specification to be solved by the invention, i.e. it therein didn't indicate that it knew its invention solves this problem, nevertheless this socially unreasonable extension of its granted patent monopoly potentially cannot be excluded, if it argues that straight-forward KR considerations implicitly disclose this indication, which case specifically may be undeniable.
ii.) Seen from the patent precedents makers point of view, 35 USC provides no clause addressing the KR issues in patent interpretation the above scope definition uses—e.g. stating, for a claimed invention's evident o-KR and a BID-KR* for it explicitly disclosed by TT.0's specification, that this problem's presentations in both KRs describe exactly the same problem⁴⁾ set out for solution by TT.0's specification for its o-KR (though this is straight-forwardly definable epistemologically/mathematically and absolutely consistently to established patent precedents), i.e. stating that P.0=P* in this scope definition—and thus would require a Highest Court's respective decision.
iii.) Seen from the point of view of the patent holder, this “broadest preemption interpretation” for determining the scope(TT*) (not to be mixed up with the USPTO's “broadest reasonable claim interpretation” for determining the scope(TT.0)) would imply totally counterintuitive and irrational refusals of applied for resp. destructions of granted patents if scope(TT*)≠φ. This namely would occur e.g., if—after having granted patent protection to a claimed invention TT.0 being subject of certain limitations and solving a certain problem P.0 disclosed by its specification—some new patent application discloses a claimed invention TT* subject to a “relaxed” limitation, i.e. TT*≦TT.0, but this relaxation being an additional limitation on one of TT.0's inventive concepts (see end of ii)), and solving exactly the same problem disclosed by its specification, P*=P.0. Then—as already at priority date of TT.0 the TT* belonging to the so defined scope of TT.0—it ought not have been granted (as being preemptive and therefore not-patent-eligible) and therefore would now be destroyed. At the same time TT*—classically potentially indicated patentable (as to aspect 7, i.e. being novel and nonobvious) now may be challenged to be idempotent (by aspect 9, see below), i.e. being potentially non-patent-eligible (see ii)).

Although intuitively felt clear, this perilous definition of nonpreemptivity of a claimed invention resp. its claim is supported by the “not-an-abstract-idea-only, NAIO” test¹⁰⁾—as criterion for the claimed invention's nonpreemptivity. This NAIO criterion's/test's three main advantages are summarized as follows: ) It is self-contained, i.e. tests TT.0 and its claim independently of posterior art, ) a claim (resp. its claimed invention resp. its refined claim construction) passing/having it is nonpreemptive, and ) it is also necessary for the claim's nonpreemptivity, whereby all these statements assume that we are dealing with a non-pathological TT.0. This leads to the

### THEOREM

A non-pathological¹⁾ TT.0 is nonpreemptive iff it passes the NAIO test.

### Proof: see Section III.1¹⁴⁾.

But the Mayo decision induced, besides the notion of (non)preemptivity of a claimed invention¹⁰⁾, also the notion of its “idempotence”^{6),11)}—indispensable in systematic thinking about the question of a claimed invention being patent-eligible. Indeed, the Supreme Court explicitly noticed in its Mayo decision that there is a logical gap in the current patent precedents when dealing with a natural law based invention by stating that it hitherto has no recipe how to deal with the distinction between patent-eligible inventive concepts and patent-ineligible ones. This gap is closed, next, by the “idempotence” aspect of a refined claim construction. It is, as a side-effect, a notion suitable for approaching the problem of trivial or useless patents, also not yet tackled by Highest Courts' precedents.

From the point of view of systematic thinking, for a claimed invention the refined claim construction proven to own all the aspects 1-7, its nonidempotentivity is the patentability logic complement to its not being-only-a-natural-law and its not being-only-an-abstract-idea of the claimed invention (=its being nonpreemptive). The Mayo decision namely clearly stated that a claimed invention involving a natural law nevertheless may deserve patenting, iff it is neither only-a-natural-law nor an-abstract-idea-only of it (=preemptive), thus implying that it then is patent-eligible anyway. For such a claimed invention, its nonidempotence concern/aspect 9) is more limiting than its nonobviousness concern/aspect 7). I.o.w.: The total “semantic height”¹⁾ alias total “creativity” of such a claimed invention must exceed ordinary pertinent skill/creativity even if it is reduced by natural-law based creativity alias semantic height—if it should at all comprise any such “poisoned” creativity, as it is seen from the patent granting point of view.

### II.6—Conclusions as to Inventive Concepts, Implied Refined Claim Construction, and the NAIO Test

From the point of view of advanced IT, the KSR/Bilski/Mayo/Myriad line of Supreme Court decisions requests refining classical claim construction—at least for a model based invention, i.e. a “non-machine-or-transformation”—type invention, as typical for emerging technologies—by “inventive concepts”. Due to the non-tangible/non-materializable plainly mental subject matter of such inventions this notional refinement of classical claim construction by inventive concepts is namely absolutely indispensable for excluding confusion about the boundary between the underlying model and the claimed invention—by totally “encapsulating” the descriptions of the interfaces between both as well as the creativity embodied by the latter into simple and clearly separated units, called “inventive concepts”^{4),5),II.3-4}.

The CAFC became specific about this Supreme Court's request and asked, in its above invitation of Amicus Briefs, for the “aspects” of a so refined claim construction according to 35 USC §112—when testing whether its claimed invention meets the requirements stated by 35 USC §§102, 103, 101 to be met by it for being patentable and patent-eligible.

Both Highest Courts thus triggered a paradigm shift in patent precedents in terms of substantially increasing its subtlety and preciseness, enabled by an avalanche of insights achieved by Mathematical Knowledge Representation research focused on this issue and greatly facilitating testing whether a claimed invention passes its test under these 4 Sections of 35 USC. Yet, this increased subtlety and preciseness of patent precedents—putting it onto a substantially increased level of evolution—comes along with several legal questions as to this refined interpretation of these 4 Sections of 35 USC. These will be answered by Highest Courts patent precedents when they practically show up, some of them being really fundamental as to the interpretation of §101—see the Supreme Court's recent decision in the AMP vs Myriad case, by plainly legal arguments in its result fully confirming the view of advanced IT^{4),5)}. Some of these questions are touched already in this patent application, other ones completely skipped, as the underlying problems are not yet understood¹²⁾. Yet, whatever these future precedents will decide on them within the current framework, it will induce developing additional and refining the so far matured advanced IT—thus increasing its potentials as innovations stimulating technology by its innovation expert systems.

In total and as of today: Mathematical Knowledge Representation based research, focussed on exactly this overarching problem of claim interpretation in patent precedents applicable also to model based claimed inventions, only recently proved¹¹⁾⁻²¹⁾ that ) these 4 sections of 35 USC interpreted by these 5 unanimous and hence irreversible Supreme Court decisions ) imply identifying exactly 10 such new aspects/concerns of the refined claim construction, which are necessary and sufficient for regaining also backwards looking consistency and predictability in patent precedents, and also ) for showing the principle governing the cooperation between District Courts and the CAFC in patent interpretation, ) whereby no alternative is known to introducing the Supreme Court's “inventive concepts” and putting them onto the constitutionally and scientifically secure fundament presented here, as these consistency/predictability objectives of patent precedents got to be achieved.

### III. THE 10+ TESTS ENABLED BY INVENTIVE CONCEPTS

In spite of initially looking not quite trivial^{II.3.1}, the notion of “inventive concept” enables easily/automatically overcoming intricacies in claim construction, several of them being hitherto unnoticed by the vast majority of the community of patent professionals/practitioners. This term/notion enables the user of the below 10+ tests to avoid such intricacies. I.e.: They provide the indispensably common fundament for developing, for these 4 §§of 35 USC, the currently missing consistency in patent precedents—required for enabling the community of patent practitioners to recognizing that the analysis and evaluation of a patent by the person of pose, an expert, an Examiner, a Lawyer, and a court is the same and hence highly predictable. As a legal system ought to be.

Much of these tests is currently applied already in classical claim construction, when orderly obeying the directives provided by the Graham/Markman/Phillips/KSR/Bilski/Mayo/lntuit/LBS/Myriad/. . . decisions—though not explicitly. This application often occurs without really understanding all these kinds of intricacies' relations to the decisive sections of 35 USC, first of all its §112 (see claim 1). For advanced IT this shows that the professionalism in classical claim construction was still in its infancy and currently develops to more maturity¹⁰⁾, supported by the here claimed 10+ tests. They not only canonize the refined claim construction—as indispensable for predictable and consistent patent precedents, anyway—but also are key to developing patent expert systems, such as the IES.

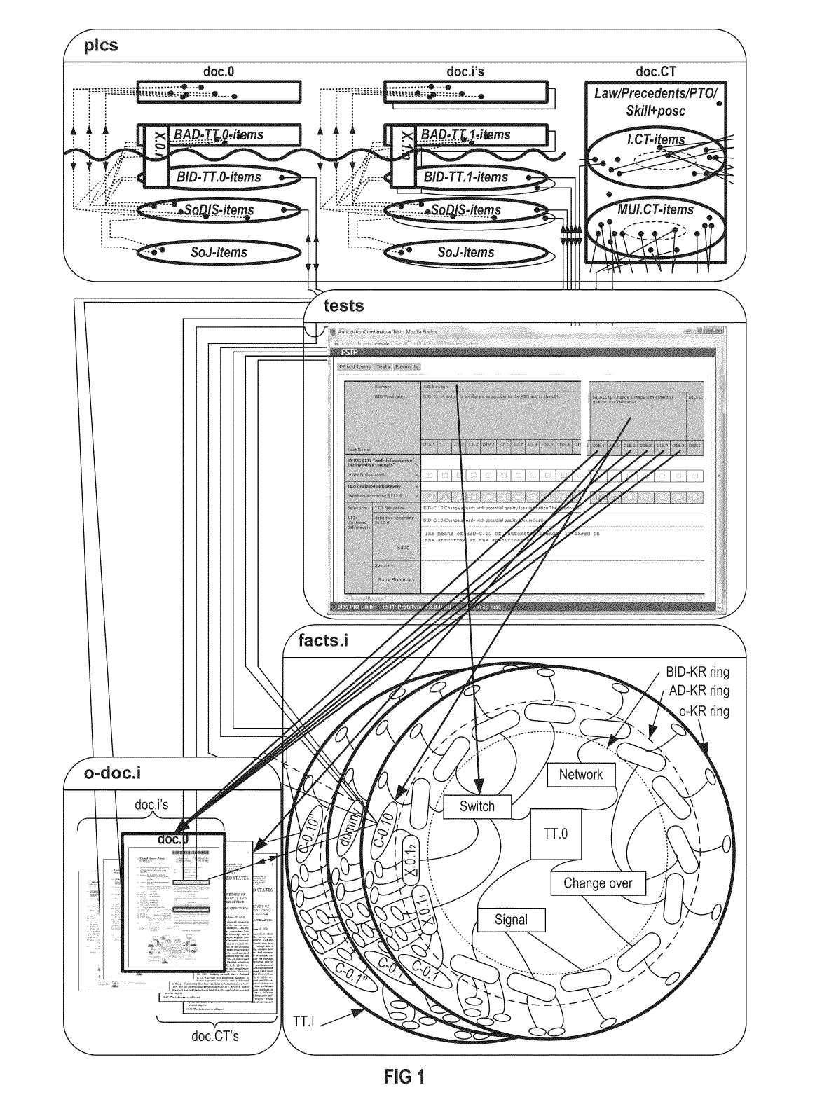

Any such test here is designed^{IV.} for augmenting a PTR-DS by information about it and the PTR it comprises, derived from both—primarily by its user—by running this test. Once more and quite clearly: Presently many steps of any test must be performed by the user¹²⁾. Yet, a test's prompting its user through its steps—classical terms as well as inventive concepts minded steps—is of greatest help for the user running it. The information provided by the user during running a test is appropriately stored in the PTR-DS, making the test thereafter automatically executable in real-time^{I}. This Section III outlines these 10+ tests enabled by inventive concepts of a claimed invention and their legal necessity and sufficiency—after first briefly recapitulating¹⁾ their presentation at the GUI of an IES by FIG 1. It shows the overall structure, above the wiggly line, of all interrelations between the '902 BAD-in-Cs and TT.i-/ICT-items—and below it the details of these interrelations.

I.o.w.: It shows the 4 Knowledge Representations of IES/FSTP technology modeling all knowledge comprised by the 10 FSTP Tests in four separate windows of the IES'es UI, simultaneously mapped onto its “survey” window, identified by the acronyms “o-doc.i”, “facts.i”, “pics”, and “tests” at their top left edges—standing for the information/knowledge representations of/about ) the original document.i's, ) their facts on the o/BAD/BID-KR levels separated by concentric circles, ) their “patent logic carrying semantics” items on these levels in all doc.i's separated by the wiggly line, and ) the 10 FSTP Tests.

Any one of these windows may be arbitrarily zoomed, positioned, and overlapped within the survey window. The graphical items within these four windows basically represent inventive concepts and/or their components in these KRs, the lines between these items represent their interrelations.

The IES'es UI presents—functionally top-down and in telegram style—in its survey window, on the
right upper side, in the “tests” window, an overview about the use of the claimed invention's inventive concepts, represented by the matrix columns, by the various tests, represented by the matrix lines.
right lower side, in the “facts.i” window, a stack of 3 TT.i—per TT.i arranged on its plane in concentric “KR rings” (delimited by dashed lines) and its items having KR specific shapes (the large/small ellipses representing BAD/BID-cr-Cs), one being selected and hence showing some relations—and
left lower side, in the “o-doc.i” window, the two stacks of the peer 3 doc.i's (their mark-ups comprising all cr-Cs' disclosures) and of the doc.CT (their mark-ups comprising all Ie-Cs, i.e. law/precedents items applicable).
left upper side, in the “pics” window, doc.0's subject matter items (cr-Cs) interrelating with its legal items (Ie-C) and the subject matter items of doc.i resp. dummies.

The lower right side facts.i stack provides to the user the overview about all the subject matter items existing at all in a claimed invention's analysis—enabling it to easily accessing and zooming into any one, checking for its being lawfully disclosed as visualized (on the left upper side) by showing all its technical and legal relations and their reasons resulting from the stacked doc.i's and doc.CT on the left lower side. The survey window provides:
immediate access to ALL information/knowledge existing in any one test of the claimed invention.
immediate and instant crossover from ANY ONE subject matter item to its peer in any TT.i—and back.
immediate crossover from ANY ONE subject matter item to ANY ONE of its relation—and back.
immediate crossover from ANY ONE relation to its peer in any TT.i—and back.
immediate crossover from ANY ONE test using an item or relation to any test and its use thereof.
immediate information about impacting by a change performed in one of the 4 windows other windows,
and all these services instantly, i.e. in “dialog real-time”.

There is an important difference between the PTR-DS part with or without the BED-C part (below the wiggly line) and the result of applying the claimed FSTP Tests in explorative mode to it. Both, above and below the curled line, clearly model the work done by a tester's brain. While working on the former part, it makes its owner aware of the structure of this work, though not of its details—provided it works rationally and disciplined. The latter part models the details of the work done by the brain—focusing its owner's awareness on these details, dealing with the overall structure “sub-cortically”, i.e. leaving the owner no chance to grasp whether it is working correctly or not. This working of our brain inevitably is error prone. That is what makes the scientific approach to a problem so important, as it greatly increases the chance to assess that the details elaborated on indeed contribute to correctly solving the problem as a whole.

### III.1—Further Notional Clarifications as to the 10 FSTP Tests

For an abstract PTR's claimed invention—described by a given finite set of inventive concepts, i.e. by the abstract inventive technical teaching, TT.0—the Section II.5.2 explained, why the 10 aspects/concerns of TT.0's refined claim construction are necessary and sufficient for deciding, whether TT.0 passes all 4 §§of 35 USC. Thereby any one of these 10 aspects/concerns—just as their subsequent implementations as concrete tests, being applications of the there presented scientific insights—may only identify its resp. specific semantics: It namely is to be fully determined or selected by the user during this test's explorative executions, anyway documented what it considers to be the correct answer to the resp. question asked by the IES. Thereby the user is not restricted in any other way. I.e.: It is also free to input false statements, voluntarily or involuntarily—today everything must be accepted and documented, as currently is the case with any lawyer's presentation in this situation, ongoing semantic research¹²⁾ will definitively achieve some progress. I.e.: Today, all 10 FSTP Tests—and their customizations by the control claims—also work, if their user doesn't care e.g. for the logical need of the inventive concepts' disaggregation or simply performs it erroneously. In both cases the Examiner, or the counter party, or a court is responsible for detecting this deficiency.

How to specify such semantics precisely has been outlined mathematically earlier^{1):D3-5,N3-5}. A test's resp. semantics information provided by the user—its preciseness hence today being that of currently typical patent disputes—has been, by the end of its explorative execution, automatically integrated into the given PTR-DS such that an IES is enabled to automatically repeat it thereafter at a user's query, i.e. automatically retrieve and present this information in real-time in a confirmative test execution. Thus, an explorative or confirmative test execution serves for expanding a PTR-DS by information about its legal and technical facts concerning its TT.0 over its RS, resp. for verifying this information in real-time.

The wordings of 20 method and system claims specify the 10 FSTP Tests' explorative functioning. For the respective confirmative claims' wordings—the former ones vastly comprise them—see a further patent application. In both cases, there is a “customization problem” and a “sequencing problem” with any FSTP Test, which are taken care of by 10 claimed “test control” inventions described by the end of Section III.2, after commenting on the claimed ground laying 10 FSTP Test applications/inventions. Depending on these claimed test control inventions, a PTR-DS expansion by executing the 10/20 FSTP Tests exploratively may affect BED-TT.0 and BID-TT.0 of PTR-DS to dramatically varying extents, elaborated on later—and accordingly their confirmative executions.

Thereby, a PTR-DS instantiation initially always comprises at least .) its complete PTR-DS declaration explained earlier¹⁾, i.e. the declaration of any inventive concept of any PTR-DS and all its potential interrelations, plus instantiations for the PTR specific :) document.CT and all doc.CT-MUIs therein, .:) all document.i's and all their specific doc.i-MUIs, and ::) all peer elements X.i.n and their peer concepts BAD-X.i.n, 0≦i≦l, 1≦n≦N. It may also comprise additional information about its PTR and/or the future use of PTR-DS—not elaborated on, here. During exploratively executing the 10 FSTP Tests any one of these sets of instantiations—some of them may be “dummies”¹⁾—may be changed, as explained in Section III.2.

Finally to the proof of the above Theorem announced in Section II.5.

From aspect/concern 10/25, i.e. from the Supreme Court's exclusion of a claimed invention, abbr. TT.0, from patent-eligibility if it is either ) only a natural law, or ) only an abstract idea of this claimed invention (here understood as: its specification does not disclose the problem P.0 set out for being solved by it), or ) preemptive (as defined above, also requiring the disclosure of problem P.0), logically trivially follows that this scope is determinable only if this specification identifies this problem, P.0¹⁰⁾. It actually is determinable if the specification (including the claim's wording) identifies this problem, P.0¹³⁾, and even better: The consequence is the proof of this theorem. The EPC anyway supports the “problem solution approach” to drafting a patent and its claim(s).

Thus, while this “patent technology” induced by the Highest Courts is intellectually only slightly more demanding than the hitherto sufficient plain knowledge of patent precedents, it yet dramatically reduces—by its many automatisms—the amount of time needed and likewise dramatically increases the quality of testing a claimed invention under 35 USC §§112,102,103,101^{14),15)}.

### III.2—Comments on the 10 Fundamental and 5 Augmented Tests' Peer Claims

First the limitations of the 10 ground laying abstract tests are commented on, as implemented/described by the claims 1-10 and 16-25. Any peculiarity of these implementations, called FSTP Tests, may hold for several claims, but it is explained only with the first claim encountering it, thus shortening later comments.

After these 20 fundamental patentable claims alias FSTP Tests, 10 method and 10 system claims, also 5 abstract “reach and sequencing, R&S” controls of them are commented on, patentable as subclaims 11-15 and 26-30. As the clause (b) of the wording of claim 1/16 describes, by their taking over the control in it by not using an IES'es default control, they determine the control in all its subclaims, as determined by them. The limitations in total exerted on claim 1/16 are caused by 3 different reasons, vastly independent of each other: By .) the given BAD-KRs, and for any such BAD-KR, by :) the 4 reach limitations of the control claims, and their .:) single sequencing subclaim. Thereby a crucial aspect is that the 10 tests are to be understood conjunctively. I.e., in general, any test based on the default control of this clause (b) may approve options on inventive concepts disapproved by a succeeding such test, which may require iterations as to the user's selections of options. One often more efficient way for determining inventive concepts approved by all 10 tests—potentially even all such inventive concepts of a claimed invention, which probably is the most important aspect of the here disclosed “patent technology”—is the noniterative one, described by subclaim 15. Though, in other cases, it may be unnecessarily voluminous.

Another commonality of all 30 claims is that they all operate on a clearly and completely defined finite sets of doc.i-MUIs and doc.CT-MUIs and only on these, guaranteeing that all their decision problems are finite as based on MUI combinations, i.e. have only finite arg-chains (modulo redundancies in using MUIs).

Also: The below comments identify a whole range of KR questions with a claimed invention, not yet settled or only identified by today's patent precedents—though they improve the understanding of the sophistication of some (probably not all) intricacies inherent to patent precedents. The here claimed inventions, i.e. their claims and this specification underlying them, show that and how these intricacies may be dealt with in a way absolutely consistent with current patent precedents, i.e. fully comprising it, and nowhere leaving from the firm scientific ground as provided by fundamental/axiomatic mathematics and advanced IT. For granting a patent to a claimed invention alias TT.0, it must pass all 10 tests. Otherwise it is impossible to exclude untenably inconsistent patent court decisions about model based claimed inventions. This would put into jeopardy the credibility of patent precedents again, also on this basis—just by using it inappropriately.

Finally: All the claims are drafted such as to be completely independent of changes that potentially may take place as to the currently used terms in Highest Courts' patent precedents, of options used in associating them to particular notions (within the framework set by the Highest Courts), and of the underlying patent law—which means a significant step forward on the way of harmonizing them. To this end the claims decompose any inventive concept BED-C0.k into its BED-cr-C.0.k and BED-le-C.0.k, which they denote as BED-cr-C.0.k's legal “justification”—which would vary between the various national patent laws.

As to test 1: In claim 1, just as in several other claims, there are automatic prompts of the user to “input” some information (here: the BED-cr-C.0.k's), without telling him/her, where to find it—this also holds for any KR_R&S_S preset by the user in clause (b). In principle: This information is provided to the user either by (the only finitely many) MUIs of the doc.0 and/or doc.CT (here: only doc.0, yet in view of doc.i with i>0), potentially supported by the person of pose in searching for it therein—in doc.CT it may be put already in some wording predesigned e.g. for the tests' purposes (see control claims 11 and 26)—or by the PTR-DS itself, from which the user may pick it up. It often would be trivial, e.g. if an inventive concept BAD-X.0.n to be disaggregated is already a BED-cr-C.0.kn (see claim 2, i.e. the below comment on it), or at least simple, if e.g. Kⁿ=1∀n, and this applies for all KRs. Also then this test—depending on clause (b)—still is necessary for updating the given PTR-DS such that the remaining tests may be executed on it, when elaborating on all (only finitely many) alternative arg-chains.

Thereby “updating” firstly means generating—as required by the test claim at issue, potentially limited by one or several customization claims—additional inventive concepts embodied by PTR-DS, if not yet existing, and/or inserting information into such instantiations and/or overwriting information therein already and/or appending information to them, although the original concepts do not foresee such operations. Secondly it means, writing such modifications of the memory's current PTR-DS—initially defined in (a)—into the memory.

For simplicity, claim 1 assumes that for any KR the set of BED-cr-C.0.k's is a priori given by the user (see claim 2)—as seen by it¹⁷⁾—for its explorative execution, and for its affirmative execution accordingly automatically input for it. And the same simplification holds for any input to be provided by the user in the other claims. There are no limitations as to the given formats or notations used thereby. Any such input may be explicitly confirmed by a technical and/or legal expert and/or by an Examiner—as separately provided for by the test control claim 12.

It also would often not be clear to the user, at the time of starting this test, how fine the final elementary inventive concepts should be, into which a compound inventive concept is to be disaggregated, i.e. into how many elementary concepts—though this question is evidently of great importance to all other tests. This question has been clarified earlier already by stating that such a disaggregation often inevitably is an iterative process, which may be started with an initial refinement whatsoever of a compound inventive concept, this refinement then may be changed iteratively, and the final refinement of which need not be unique—though only finitely many exist (see claim 2).

During any disaggregation of a compound inventive concept of TT.0—usually provoked by finding a similar but in truth yet different peer compound inventive concept in a doc.i, i>0, whereby the presentation of this difference is facilitated by its such disaggregation—it may happen that an initial BAD-X.0.n got to be “enriched” by an additional property/concept and/or doc.i-MUIs got to be accordingly “enriched”, e.g. by their concept instantiation specific refinements/extensions, as taken care of by the 5 test control claims. As it states, this may occur also while executing a step of one of the other claims, and even may comprise generating additional doc.i-MUIs, i≧0. Such refinements of the understanding of a claimed invention usually occur, if a PTR's initial RS is expanded by an additional doc.i. Though, doc.0 always enables for any BAD-X.0.n only a finite number of disclosures and hence disaggregations.

As to test 2: The Markman/Phillips decisions elaborate on the existence and clarity requirements the disclosures of a claimed invention must meet, i.e. its “inventive concepts” (=BED-C0.k) of the Mayo decision. As to a claim's means-plus-function construct, the Markman/Phillips decisions leave room for additional limitations (see test 3), just as they do not address the issues identified by the aspects 5)-10). Remember: The claims decompose any inventive concept BED-C0.k into its BED-cr-C.0.k and BED-Ie-C.0.k, which they denote as BED-cr-C.0.k's “justification”.

This test shows that—as seen by its user¹⁷⁾—all elements of a set {BED-cr-C.0.mⁿ, 1≦mⁿ≦Mn}, 1≦n≦N, in one or several KRs of PTR, meet the presentation requirements as stated by the Markman/Phillips decisions.

As no precedents exist yet as to these decisions' dependency on a claimed invention's KR, the claim 2 may elaborate on any such KR, due to clause (b) in claim 1—as specified by claim 14. It invokes the (finite) number of different o-/BAD-/BID-KRs and hence may be elaborate. By contrast, its default control is limited to considering, of a PTR-DS, only one given BAD-KR and checking it for having at least one lawful disclosure in doc.0 of any BED-cr-C.0.k instantiation. This already exceeds today's patent precedents—implicitly assuming, there is only one BAD-KR.

All of today's patent precedents also implicitly assume, there is only a single instantiation of any BED-cr-C.0.k, while “BED-cr-C.0.k multi instantiation” questions do arise in existing patents. Today they are to be answered completely by the test user, later possibly partially automatically¹⁰⁾, but in any case embodying much uncertainty. This “inventive concept multi instantiation” question has not yet been clearly considered as such by patent precedents, though it does crucially arise in existing patents, is clearly implied by its means-plus-function construct (see test 3)¹⁶⁾.

As to test 3: This test shows that—as seen by its user¹⁷⁾—for any BED-cr-C.0.k at least one set of its instantiations used in a means-plus-function clause, {BED-cr-C.0.mⁿ}, the specification provides at least one definite disclosure of BED-cr-C.0.k, here comprised by DIS^{sel}({BED-cr-C.0.mⁿ}).

I.e.: Test 3 checks, whether the requirements stated by the LBS/Intuit decisions—and to be met by any inventive concept BED-cr-C.0.k of a patent's claimed invention, an instantiation of which is used in a means-plus-function clause, i.e. which is disclosed by a means-plus-function (“35 USC ≡112.6”) disclosure—are actually met by at least one disclosure of at least one set of instantiations of any BED-cr-C.0.k, which is used by the resp. means-plus-function clause. These requirements to be met by this disclosure and this BED-cr-C.0.k are: .) Both have passed test 2 and will pass test 4, whereby :) there is a function explicitly identified by this claim's wording, and .:) a structure explicitly identified by the specification, by means of which this function is implemented, and ::) the algorithm described in the specification, for describing this structure's working, actually implements the function needed by the “means-plus-function” clause of the claim for making its scope of protection clearly describe the claimed invention's scope of protection, as described by the specification according to tests 1, 2 and 4.

Thereby the LBS decision deals with the question of the need of an explicit identification of a structure—which the CAFC affirms (whereas the specification of the patent at issue does not explicitly identify it). And the Intuit decision deals with the question of the need of an algorithm implementing by means of this structure the exact function defining the claim's scope¹²⁾—which it also affirms (whereas the specification of the patent at issue does not describe an algorithm using this structure and implementing its exact function, although it defines the claim's scope). If one of these just quoted 4 requirements is not met, these decisions recognize for right that the scope of this claim is not uniquely defined and hence is not meeting the §112.6 requirements—that it then is legally invalid.

As to test 4: This test shows that—as seen by its user¹⁷⁾—any instantiation of any BED-cr-C.0.k in its BAD-X.0.n, i.e. any instantiation of any BED-cr-C.0.k in its BAD-X.0.n, is described enablinqly by the specification—unless the person of pose knows a priori how to implement it in this instantiation's context^{II.3.2}.

A BED-cr-C.0.k used outside of its BAD-X.0.n for defining an instantiation of a BED-cr-C.0.k′ may cause a dependency between these two BED-cr-C.0.k's (see test 5), but it there is not subject to this enablement question.

As to test 5: As elaborated on earlier¹⁾ already, the claimed invention's inventive concepts must be independent of each other—otherwise they indicate a semantic height too great, of the claimed invention alias TT.0 over the RS. This (probably unintentional) deceiving does occur in existing patents, without being noticed by their PTOs.

Implicitly the BGH's Gegenstandstrager decision and the Supreme Court's KSR decision induce how independency of creative concepts ought to be defined for enabling detecting their dependency and thus excluding this misrepresentation of TT.0. Accordingly, the notion of independency has tentatively also been mathematically modelled¹⁾; minor changes of this mathematical definition may be appropriate, but today patent precedents do not care for such subtleties. From these considerations anyway logically follows that a combination of BED-cr-C.0.k's resp. of BID-cr-C.0.k's—potentially part of this notion—can be only a FOL expression of their mirror predicates¹⁾.

This test shows, for whatever set of BED-cr-C.0.k's or BID-cr-C.0.k's considered, that—as seen by this test's user and whatever notion of independency he/she applies¹⁷⁾—all its elements are independent of each other.

As to test 6: The need of a claimed invention's any inventive concept, BED-cr-C.0.k or BID-cr-C.0.k, to be non-equivalent to a BED-cr-C.i.k′ or BID-cr-C.i.k′, i≧0, is ex- and implicitly frequently addressed in patent precedents. Thus, it is assumed to be sufficient, what the user inputs into this test for justifying that no such equivalence exists.

This test shows, for whatever set of BED-cr-C.0.k's or BID-cr-C.0.k's considered, that—as seen by this test's user and whatever notion of non-equivalence he/she applies¹⁷⁾—all its elements are non-equivalent to each other and to their peers of TT.i's, i≦0.

As to test 7: This “NANO test”, formerly¹⁾ called “FSTP Test”, for a claimed invention's “JNovelty And NonObviousness” alias creativity¹⁾ is included here, as further limitations are imposed on it not existing earlier, i.e. its integration into the PTR-DS, whereby the “NANO test [{set of inventive concepts}⊂Q PTR-DS]” stands for its execution by using only this {set of inventive concepts}. It is important also when screening a claimed invention for its patent-eligibility, as performed by the FSTP Tests 8-10.

This test shows—as seen by its user¹⁷⁾—not only the creative height≧0 of PTR's TT.0 alias claimed invention over PTR's RS, but also all reasons for the creative secondary technical facts causing this creative height.

As to test 8: This “not only a natural law” and the two remaining tests implement the Supreme Court's “exclusion from patent-eligibility principle”. Hence, at the time being, no further comment is needed here¹⁷⁾.
As to test 9: The reason for suggesting the notion of idempotence of a claimed invention also has been provided earlier: A claimed invention namely may pass all the preceding tests, although its patent did not disclose that it embodies a resolution of a problem of a kind, for the stimulation of the search of creative solutions of which the patent law has not been established by society, e.g. for it unethical or stupid problems.

In particular, this test may check a claimed invention for its non-idempotence beyond its use of a natural law. Thus, this test 9 enables checking—together with test 7—a claimed invention for exactly the quality the Mayo decision queries about it. Determining this quality of a claimed invention also has been provided earlier¹⁾, there being called the “pragmatic height” of TT.0.

This test shows—as seen by its user¹⁷⁾—not only the pragmatic height≧0 of PTR's TT.0 alias claimed invention, but also all reasons for the pragmatic secondary technical facts causing it¹⁾.

As to test 10: This NAIO test^{4),5)} of the claimed invention checks the claimed invention for its being “Not an Abstract Idea Only”. It is the sibling test to the definiteness test 3, as the the claim's clarity is at stake in both tests. There its scope becomes indefinite because of its inadmissible use of a means-plus-function construct, here because the claim tries (intentionally or unintentionally) to get patent protection for more than its patent actually discloses as invention, i.e. because it is preemptive. Test 10 hence checks a claimed invention exactly for the transparency of its scope definition, as the Mayo and the LBS/Intuit decisions also ask for.

This NAIO test shows that—as seen by its user¹⁷⁾—the scope of this claim cannot comprise (i.e. unintentionally embody or intentionally strive for) a solution of a problem as being the claimed invention deserving patent protection, which the patent (application) does not specify as such^{II.3.3,III-1}.

Finally, some “controls” of the 10 preceding abstract tests are provided. Two kinds of such controls are crucial, for which the claimed method/system inventions 11-15 and 26-30 are just exemplary. Namely: Such tests'
“reach customization controls” determine a set of legally potentially relevant variations of these tests. E.g., the default is to check only a single one of some set of potentially crucial alternatives, but claim 14/29 may determine that always the whole such set is to be checked. In between, a variety of exhaustion strategies for sets of alternatives may be useful for solving the problem to determine an appropriate trade-off between effort for expanding a PTR-DS and gaining additional security by it. The reach customization controls 11-13 and 26-28 are even more evident than 14/29. Any one may be imposed, by the user, on any one of the test claims.
“sequencing customization controls”, claims 15/30, enable the user to solve the sibling problem of finding an efficient strategy for sequencing any test's steps of execution in exhausting the set of alternatives determined by the above reach controls.

Reach/Sequencing customization controls are applicable in explorative and in confirmative testing: While a preconceived automatic reach or sequencing customization usually is not changed in real-time during explorative testing and often also during confirmative testing (e.g. for supporting a presentation in a precisely preconceived way), the latter mode of testing may require changing between different customizations in real-time (resulting e.g. from automatic real-time keyword spotting in an acoustic information flow and the potential need to instantly switching to a different reach and/or sequencing customization mode).

Reach claim 11: This “predesigned test and test mode specific input wordings” customization would dramatically simplify the explorative and confirmatory work of e.g. the Examiner and/or of an automatic semantics prover¹²⁾, if it is sure that the wording of the test specific input provided by the user is taken from a library recognized by some credible authority, i.e. known to be free of linguistic and/or logical intricacies—and perhaps even familiar to him or it.
Reach claim 12: This “person of pose confirmation of inputs” customization would evidently also dramatically simplify the explorative and/or confirmative testing by the Examiner—independently of and/or additionally to claim 11—if this person of pose is recognized by some credible authority.
Reach claim 13: This “enrichment by additional invention relevant information” customization serves for exploratively changing a test as to its use of some information in doc.CT or a doc.i, i≧0. This may comprise adding to or removing from the PTR a doc.i, i>0, modifying doc.CT, identifying another inventive concept of TT.0, and/or . . . , potentially marking this information up accordingly by the user as respective MUls or changing them.
Reach claim 14: This “exhaustion degree of a set of alternatives” customization changes explorative and/or affirmative test execution as to using one or more or all of its alternatives, the latter reach is called “total” testing.
Sequencing claim 15: This test “execution sequence” performance customization serves for changing an explorative and/or confirmative test's execution sequence of its steps in a way prescribed by the user, who to this end would input his execution sequence policy. He may dynamically alter any customization—including reach customizations—in real-time for adapting it to his/her current needs, caused e.g. by an actual explicit query, or automatically identified by word spotting and thesaurus checking. While explorative testing today always works semi-automatically, confirmative testing may run fully automated, including all tests being total (i.e. fully exhaustive).

### V. ANNEX: THE CLAIMED INVENTIONS, I.E. THE ABSTRACT TEST APPLICATIONS, MEET 35 USC §§112/102/103/101

This ANNEX to the specification of this patent application shows—abbreviated, due to the lengthy preceding elaborations as to this issue—that the 30 claims meet the requirements of 35 USC §§112/102/103/101. As suggested earlier¹⁾, in the future any patent application should provide this ANNEX, though a perhaps more detailed one, describing its self-estimation of its claimed invention(s) meeting the requirements of the applicable patent law, thus facilitating its Examiner's work: It simply must show that its claimed inventions pass the 10 FSTP Tests—as is shown next, here.

In this patent application, an additional simplification is possible. Any one of the 30 claims is an application of the inventive concepts and their BID-cr-Cs defined by the PTR-DS patent application^{1)-V.2}, e.g. of the BAD-TT.0-, BID-TT.0-, SoDIS-, SoJUS-concepts, which thus need not be defined anew. Also their elementarity is assumed to be sufficient, i.e. FSTP Test 1 to be superfluous. Yet the other 5 properties of all inventive concept—used in justifying the claimed inventions' patentability and patent-eligibility—must be reconsidered in the FSTP Tests 2)-4), 5), and 6)—as implied by the Highest Courts' patent precedents and explained in Sections II.3.2-6. But, first the parameterized range of all the 15 problems of P⁹⁾ must be kept in mind, which are to be solved by the accordingly parameterized range of claims 1-15/16-30. For the 10 test and the 5 test control claims, these problems are clearly specified in Section III.2 by the respective comments on them. They show, in particular, that this problem description may be identical to the descriptions of their claimed invented solution—indeed their inventive-C-descriptions must be identical iff the same BID-in-Cs are used in both descriptions—but different KRs may be used for both^{13),14)}!!!

As to §112: The disclosures of these original inventive concepts exist in the lawful form and remain clear, definitive and enabling as to all 10 FSTP Tests. Hence, all 30 claimed inventions meet the §112 requirements.

As to §102/103: From test 7 immediately follows for any one claim, as no prior art is known: For any one claimed invention holds that its semantic height over skill is Q^{pics}≧12, due to the 12 original inventive concepts evidently being independent and nonequivalent (up to tests 5 and 6). Hence, all 30 claimed inventions meet the §102/103 requirements.

As to §101: None of the 30 claimed inventions is either a) a natural law only, or b) idempotent, or c) an abstract idea only, i.e. preemptive. For any one of the 30 claimed inventions' claims namely follows from
a) the nonexistence of a natural phenomenon that compiles the kind of information—from the mark-ups in the doc.i and doc.CT—about a PTR-DS in a that systematic manner, as required for real-time answering a query for this information, as compiled by any one of the explorative tests.
b) test 8 that and test 7 that there is no pragmatics reducing the semantic height of any one claimed invention, i.e. they all have Q^{pmgp}≧12, i.e. they are nonidempotent.
c) the NAIO test has shown already for the 12 original inventive concepts that somehow reducing the set of any limitations defining them disables them from solving the problems set out to be solved by them. In addition there are the 15 inventive concepts specifying their 15/30 claimed invented applications defined above and the problems they solve⁹⁾, for which this statement also applies.
   (Alternatively, and focusing on the term “abstract” instead of the term “abstract idea”: any one claim's reading and modifying a physical memory is far away from any notion of its being abstract.)

Hence, all 30 claims are indicated to meet the §101 requirements, too.

Thus, all 30 claimed inventions and their claims are indicated well-defined, patentable, and patent-eligible.

Finally, it is worthwhile noticing, once more:
The just referred to PTR-DS, expanded by executing the 10+ tests on it, would enable an IES—the one used for this expansion or another one—to reply in real-time to any query of e.g. an Examiner as to any step of any such test of its claimed invention at issue. Thus, as also suggested earlier¹⁾, once an IES is available understanding a e.g. minimal PTR-DS of publicly known format and semantics, a patent applicant or its patent lawyer should expand it as to the therein claimed inventions, by executing on any one of them the claimed FSTP Tests and submit/email the so expanded PTR-DSes together with this application to the PTO. Using the IES on these so expanded PTR-DSes—potentially one per claim, at least one per independent claim—would greatly facilitate the work of this PTO's Examiner: The IES then may even automatically⁹⁾ talk the Examiner through all the legal and technical queries and all their answers he/she might be interested in during his/her examination process of this application for granting a patent for its claimed inventions, namely by the execution of the respective affirmative tests—just as an IES originally may have automatically prompted the inventor resp. his/her patent lawyer through all these questions to be answered by him/her when “exploratively” interacting with these 10+ tests—yet now affirmatively replying them to the Examiner not only automatically but also in real-time.
The just explained holds, independently of whether these 10+ tests' peer claims themselves meet the requirements of 35 USC §§112/102/103/101—though they partially do anyway⁹⁾, as indicated above by means of them. This implies, assuming some authority had confirmed that they are correctly checking whether a claimed invention meets the requirements of 35 USC §§112/102/103/101, that the patent technology embodying them could beneficially be used this way, e.g. by the USPTO's Examiners (see above) or patent law firms or inventors for X-raying their patents' claims.
All the preceding presentations are totally 35 USC oriented, due to a major case pending at the CAFC. Yet, only marginal changes suffice to make them applicable also to other patent systems, e.g. the EPC and many other one(s).

### FOOT-/ENDNOTES

¹ “AN INNOVATION EXPERT SYSTEM, IES, AND ITS PTR DATA STRUCTURE, PTR-DS”, www.FSTP-Expert-System.com.

² “Baseline” represents a plainly legal notion, while “technical teaching” represents also the baseline's subject matter meaning.

³ The '902 invention comprises, disclosed by the '902 specification, further inventive concepts here not addressed, but yet being important, e.g. (e) “it is always initiated over the Internet” (col. 3, II. 35-39; col. 4, II. 27-36; col. 8, II. 5-13); (f) “it has always the same bandwidth and urgency requirements” (col. 2, II. 18-25); (g) “it always requires a claimed switch at the called party” (col. 3, II. 47-57); . . . A complete analysis must be applied, if the '902 invention were made subject also to the “not an abstract idea only” test that the author suggested in his Amicus Briefs to the CAFC in its CLS Bank v. Alice Corp. case and to the Supreme Court in its Ass. for Molecular Pathology, et. al. v. Myriad Genetics, Inc., et. al. case.

⁴ See the Amicus Brief of SSBG to the CAFC in its case CLS Bank v. Alice Corp, suggesting a “non abstract idea test”.

⁵ See the Amicus Brief of SSBG to the Supreme Court in Ass. for Molecular Pathology v. Myriad Genetics, qualifying the human genome as a non-patent-eligible “abstract idea” only of a large number of still unknown patent-eligible inventions.

⁶ The “Open Systems Interconnection Reference Model (OSI-RM)” is agreed on by all worldwide giant standardization bodies, such as ISO, ITU-T, IEEE, IEC, IETF, and their national counterparts, e.g. the ANSI, DIN, AFNOR, BSI, NTT. It overarches much of telecommunications' pertinent skill.

⁷ Everything said here about inventive concepts also applies to non-inventive concepts. Thereby note that this property of a C may change with the TT.i's comprised by RS^{II.1}: While a C may be non-inventive over some RS as all its TT.i's anticipate C, adding to RS (resulting in RS′) a TT.i' not anticipating C would make this C inventive over this increased RS′. As a consequence, it often happens that an allegedly inventive C of TT.0 is anticipated by adding to RS a TT.i′ anticipating this C, whereby this very X.i′.n would potentially increase the creative height of TT.0 over RS′ (as compared to TT.0's creative height over RS)—e.g. as now other formerly non-inventive Cs of X.0.n may become inventive over X.i′.n.

⁸ Note that in¹⁾ we skipped going to the BED level first and went immediately to the BID level, i.e. sometimes implicitly assumed the BED-cr-Cs being checked for their independency of each other—while here this check is made explicit, but not their other checks, namely for exactly their particular instantiation being disclosed lawfully, definitely, enablingly, and nonequivalent.

⁹ This problem P.0—set out for solution by the claimed invention TT.0's specification, e.g. in the claim's wording¹⁰⁾—may be parameterized, i.e. be a range of problems, or it may comprise several isolated problems, . . . , i.e. may be a compound of several “component problems”. In any case, the “not-only-an abstract-idea” aspect^{5),10)} of a claimed invention requires that the latter solves all such component problems. If it does not solve one of these component problems, patent protection should not be granted to this invention as being a solution of this “compound problem”. If no P.0 is explicitly disclosed by the specification as to be solved by the invention TT.0 claimed by this claim, this triple <claim, TT.0, P.0> should not be patent-eligible—unless the pose considers P.0 to be implicitly disclosed by this specification. Note that P.0 may be described only that vaguely that it may be totally solved already by some TT*<^{TT} TT.0, disqualifying TT.0 to be only an abstract idea of P.0's solution^{4),5),10),13)} and hence this triple is not-patent-eligible—also as TT.0 then is preemptive, by this preemptivity definition. Here not reparable vague descriptions of P.0 are excluded, and the “^{TT},^{P}” remind of different description requirements. ¹⁰ The NAIO test of a claimed invention was originally suggested in slightly less appropriate forms^{4),5),6)}, which is fixed here. It also is not clear, whether a pathological TT.0 exists, at all¹⁾.
The complete NAIO test would start with disaggregating the compound inventive concepts of the claimed invention into the resp. sets of BED-in-Cs, then reduced to maximal sets of BID-in-Cs therein, as explained in Section II.3.3—i.e. by checking these also for the aspects 1-9 of the claimed invention's refined claim construction. By contrast, as applied here, the so understood NAIO test's 10^{th} step of the refined claim construction (the 8^{th} and 9^{th} steps being trivial, at the time being, because of the claimed invention's properties they check) assumes, all these preceding 9 steps are already executed. I.e., step 10 does not care for the requirements, the BID-in-Cs got to meet in the claimed inventions checks in steps 1-9. Also the problem set out for solution9) may be decomposed into components relevant and irrelevant for patent-eligibility^{II.6}.
For brevity only considering the BID-cr-Cs of the BID-in-Cs, it comprises 4 steps:
1) verifies, that the TT.0's specification of the patent (application) discloses ex- or implicitly a problem, P.0, to be solved by the claimed invention/TT.0, the latter described by its refined claim construction's as owning the aspects 1-9;
2) verifies, using these BID-cr-Cs as of 1), that the so described TT.0 actually solves this problem of 1);
3) verifies for any one KRA of TT.0—of its only finitely many KRs, that there is no BIDA-cr-C of the above resp. set of BID̂-cr-Cs having passed the tests 1-9 in KR̂—that this problem of 1), P̂, is in KR̂ not solved by any TT̂*, derived from TT̂ by ignoring therein this BID̂-in-C completely or relaxing its limitation by increasing its d(BID̂-in-C), i.e. not solved by any TT̂*<^{TT} TT̂;
4) states, if all steps in 1)-3) are executed successfully, that the so described claimed invention/TT.0 is not only an “abstract idea” of this problem's solution, otherwise that it is only an “abstract idea” of this problem's solution.
Note: The Supreme Court's Mayo decision implicitly makes assumptions, e.g. as to the requirement to be met by this problem's description—just as by the description of TT.0—which are not removed by this description of the NAIO test. These must be clarified by currently not yet existing Highest Courts' patent precedents^{II.6}.

¹¹ In mathematics, the term/notion “idempotence” of an element as to an operation, denotes that this element does not change the result of this operation. Examples are: the element “0” as to the addition operation of real numbers, or the element “1” as to their multiplication operation, or the element “T” as to the conjunction operation of predicates.

¹² Semantics research, supporting more Mathematical Knowledge Representation research focused on the Highest Courts' patent precedents, will lead to further insights into the being of the problems as issue and developing further advanced IT tools, e.g. a mathematical prover for automatically performing the 10 FSTP Tests' stereotypically reoccurring steps.

¹³ Hitherto the meaning of the term “scope” of a claim of a claimed invention—just explained to be the scope(claim, TT.0, P.0)—has never been stated precisely in patent precedents, although it is crucial in many patent infringement disputes. The subtlety of the following elaborations on this notion indicates the mental intricacies, patent precedents here inevitably encounters, although they often are not noticed. Here becomes apparent, in particular, that the notion of scope of a claim resp. of the invention it claims, is tightly related to the fact that a claimed invention and its (classical as well as refined) claim construction may coexist in a variety of KRs. The “initial” KR⁰ is often left away, e.g. when writing TT.0 or P.0.
For simplicity, these elaborations focus—w.l.o.g.^{1):D3}—on only BID inventive concepts (i.e. skip BAD-X.0.n's) and the cr-Cs embodied by these in-Cs. In addition, only non-pathologic claimed inventions are considered^{I.1)}.
Let {BID⁰-cr-C.k, 1≦k≦K} be the technical facts of a set of a claimed TT.0's inventive concepts, allegedly being a solution of a P.0 in KR⁰. Let “scope⁰(<claim, TT.0, P.0>)”:: [symbol] ^{1≦k≦K}TS(BID⁰-cr-C.k)⊂ [symbol] ^{1≦n≦K}d(BID⁰-cr-C.k)=::S⁰, i.e.^{II.3.2} the product set of these concepts' truth sets in KR⁰. Thereby any d(BID⁰-cr-C.k) is a bipartite set comprising just two sole elements TS(BID⁰-cr-C.k) and FS(BID⁰-cr-C.k). Any bijection BI* of S⁰ to a set S*, i.e. of KR⁰(TT.0) to KR*(TT.0), preserving this bisection, is called a “BID-cr-C-isomorphism” between S⁰ and S*, abbreviated by “S⁰˜^{BIl S*”, whereby all truth sets in both KRs are the same mod(BI), i.e. BI*(} [symbol] ^{1≦k≦K}TS(BID⁰-cr-C.k))= [symbol] ^{1≦k≦K}TS(BI*(BID⁰-cr-C.k))= [symbol] ^{1≦k≦K}TS(BID*-cr-C.k).
Non-BID-cr-C-isomorphic mappings between S⁰ and S* are not considered here, as it is unlikely that patent precedents would consider them, at the time being, to model the same TT.0 in two different KRs.
Then let, comprising all BID-cr-C-isomorphisms KR* of S⁰, i.e. any BI*(TT.0)=TT* of a 1-element truth set in KR*, denote:

“scope(claim, TT.0,P.0)”::={ΛTT*|∃BI*:S*˜^{BI}S⁰ [symbol] TT* solves P*=BI*(P.0)}¹⁴⁾.
This definition of the scope of a claimed invention resp. its claim is resilient and operational also as to infringement issues.

¹⁴ Proof of the above Theorem. Having this definition of scope, the proof immediately follows from assuming, the contrary were true and showing this implies a contradiction. This assumption is:
∃ (<claim, TT.0, P.0> [symbol] TT* ∈scope(claim, TT.0, P.0): (A) TT.0 passes the NAIO test [symbol] (B) TT.0 is preemptive.
From TT.0's property (A) follows, by the NAIO test definition¹⁰⁾, that scope(claim, TT.0, P.0) comprises no TT*<^{TT} TT.0, contradicting the assumption just made about the existence of this TT* therein Thus the first option potentially making TT.0 preemptive is not applicable.
From TT.0's property (B) follows, by the definition of scope(claim, TT.0, P.0), and the just said, that only TT.0 itself in its KR* can cause its preemptivity by solving P*>^{P} P.0, according to the preemptivity definition's second option. This implies that TT.0 solves already, in addition to P.0, also a problem more limited than P.0. This contradicts Theorems I and II¹⁾, which state that the semantic height of a claimed invention over prior art and skill is an invariant in all its KR transformations. Thus, also the second option potentially making TT.0 preemptive is not applicable. q.e.d.

¹⁵ The so¹³⁾ defined scope(claim, TT.0, P.0) is no longer the largest scope one could think of. But its—theoretically avoidable Isomorphism¹²⁾—limitations are worldwide accepted in the (non)obviousness analysis between TT.0 and a combination of prior art documents. This invites considering them as broadly acceptable also in the (non)preemptiveness analysis.

¹⁶ See the Amicus Brief of SSBG to the CAFC in its LBS case, suggesting the verification of a claimed invention's claim construction and its meeting the 35 USC §§112/102/103/101 requirements by a test comprising the 10+ tests.

¹⁷ Though the subject matter statements of the user express just its opinion, i.e. may objectively be wrong, the plot of any test is correct and complete—i.e. the 10 FSTP Tests enforce that the “schemes” of these q/a's is correct and complete¹²⁾. In addition, at least the NANO and NAIO tests remove already today much of this today remaining vulnerability/misusability by the user of the FSTP Tests: Provided the user's Y/N type input is correct—which may be confirmed/checked by an expert in a straightforward manner—their results are unquestionable/dependable, i.e. contain no evaluation of the user.

What is claimed is:

1) A computer-implemented method for updating a given data structure PTR^{CT}-DS in a BAD-KR, both in given formats, by a set of Binary Elementary Disclosed (“BED”) inventive concepts of PTR's TT.0, called BED-TT.0, input to it by the user and by appendices to it and to BAD-KR for controlling an Innovation Expert System IES—the method (performing, for a claimed invention of PTR, its refined claim construction by here first disaggregating its compound inventive concepts, if these are not yet elementary) using a memory for storing the so updated PTR^{CT}-DS, generated by executing this method on TT.0's compound inventive concepts BAD-X.0.n of TT.0 representing their mirror predicates BAD-X.0.n of its X.0.n, 1≦n≦N—which:
(a) writes the PTR^{CT}-DS in a given BAD-KR into the memory
(b) automatically prompts the user to determine the KR_R&S_S to be obeyed during its execution, being
(b).1 either given by the IES as a default KR_R&S_S for both strategies, based on the BAD-KR of (a),
(b).2 or a KR_R&S_S input, in a given notation, by the user additionally to the BAD-KR of (a);
(c) automatically identifies in said PTR^{CT}-DS and said KR_R&S_S, in given formats,
(c).1 for a given 0≦I≦IRSI, all document.i's and all their doc.i-MUIs, 0≦i≦l, and
(c).2 the document.CT in doc.0 and all its doc.CT-MUIs, and
(c).3 all elements X.0.n and their predicates BAD-X.0.n, 1≦n≦N, for any BAD-KR in KR_R&S_S;
(d) automatically performs for any BAD-KR in KR_R&S_S, controlled by this KR_R&S_S, the steps (d).1-(d).6:
(d).1 prompt the user to input a set of BED-cr-C.0.k's—in a given notation—of TT.0, 1≦k≦K, and
(d).2 prompt the user to disaggregate any BAD-X.0.n, 1≦n≦N, into a set {BED-cr-C.0.kⁿ|1≦kⁿ≦Kⁿ}⊂{BED-cr-C.0.k|1≦k≦K}: BAD-X.0.n=Λ^{1sknKn}BED-cr-C.0kⁿ, whereby BED-cr-C.0.kⁿ≠BED-cr-C.0.k^{n′}∀n≠n′, and |{∪^{1≦n≦sN}{BED-cr-C.0kⁿ|1≦kⁿ≦Kⁿ}}|=K,
(d).3 prompt the user to input, in a given notation, ∀BAD-X.0.n a set of justifications by doc.0-/.CT-MUIs of this disaggregation into {BED-cr-C.0.kⁿ|1≦kⁿ≦Kⁿ}, denoted as SoJUS^{dagr}(BAD-X.0.n), 1≦n≦N;
(d).4 automatically append any SoJUS^{dagr}(BAD-X.0.n) to BAD-X.0.n, 1≦n≦N;
(d).5 automatically generate BED-TT.0::={{BED-cr-C.0.k|1≦k≦K}}∪{{BED-cr-C.0.kⁿ|1≦kⁿ≦Kⁿ}|1≦n≦N};
(d).6 automatically update the PTR^{CT}-DS in the memory as of (a), according to (d).4 and (d).5.

2) A method according to claim 1 (explaining the lawful disclosures of the BED-cr-C.0.kⁿ and completing them to BED-in-C.0.kⁿ by), updating PTR^{CT}-DS by the sets SoDIS(TT.0) and SoJUS(TT.0), which
(a) automatically prompts the user through each BED-cr-C.0.kⁿ in each BAD-X.0.n of the KR at issue, 1≦kⁿ≦Kⁿ, 1≦n≦N—to identify for BED-cr-C.0.kⁿ a set of disclosures, SoDIS(BED-C.0.kⁿ)::={MUI.0s disclosing this BED-cr-C.0.kⁿ}, SoDIS(BED-cr-C.0.kⁿ) being justified by SoJUS^{dagr}(BAD-X.0.n) and hence linked to it;
(b) automatically prompts the user to select at least one disclosure DIS^{sel}(BED-cr-C.0.kⁿ) from any set SoDIS(BED-cr-C.0.kⁿ) of (a), and to identify for it a set of legal justifications, SoJUS(DIS^{sel}(BED-cr-C.0.kⁿ)) ::={I.CTs and/or MUI.CTs and MUI.0s justifying DIS^{sel}(BED-cr-C.0.kⁿ)} and hence linked to it;
(c) automatically appends to any BED-cr-C.0.kⁿ its SoDIS(BED-cr-C.0.kⁿ), 1≦kⁿ≦Kⁿ, 1≦n≦N;
(d) automatically appends to any selected disclosure DIS^{sel}(BED-cr-C.0.kⁿ) the SoJUS(DIS^{sel}(BED-cr-C.0.kⁿ)) of (b), 1≦kⁿ≦Kⁿ, 1≦n≦N;
(e) automatically updates BED-TT.0 in the memory by {BED-cr-C.0.k expanded by its appendix (c)-(d), 1≦k≦K}.

3) A method according to claim 2 (explaining the definitiveness of the BED-in-C.0.kⁿ involved in a means-plus-function-clause), which
(a) automatically prompts the user for any BED-cr-C.0.kⁿ of claim 2 involved in a means-plus-function-clause, 1≦kⁿ≦Kⁿ, through its disclosures DIS^{sel}(BED-cr-C.0.mⁿ), 1≦mⁿ≦Mⁿ, 1≦n≦N, until a DIS^{sel0}(BED-cr-C.0.mⁿ) enables the user to state this BED-cr-C.0.k^{n′}s definitiveness;
(b) automatically appends this statement of (a), JUS^{def}(DIS^{sel0}(BED-cr-C.0.mⁿ)), to BED-cr-C.0.kⁿ;
(c) automatically updates BED-TT.0 in the memory by {BED-cr-C.0.kⁿ expanded by JUS^{def}(DIS^{sel0}(BED-cr-C.0.mⁿ)), 1≦kⁿ≦Kⁿ, 1≦n≦N}.

4) A method according to claim 3 (explaining the BED-in-C.0.k^{n'}s being enabling), which
(a) automatically prompts the user through any of its BED-cr-C.0.kⁿs and any of its disclosures DIS^{sel}(BED-cr-C.0.kⁿ), 1≦kⁿ≦Kⁿ, 1≦n≦N—until one DIS^{sel}(BED-cr-C.0.kⁿ) entitles the user to state that BED-cr-C.0.kⁿ is enablingly disclosed;
(b) automatically appends this statement of (a), JUS^{end}(DIS^{sel}(BED-cr-C.0.kⁿ)), to DIS^{sel}(BED-cr-C.0.kⁿ);
(c) automatically updates BED-TT.0 in the memory by {BED-cr-C.0.kⁿ expanded by DIS^{sel}(BED-cr-C.0.kⁿ) which is expanded by JUS^{end}(DIS^{sel}(BED-cr-C.0.kⁿ)), 1≦n≦N, 1≦kⁿ≦Kn}.

5) A method according to claim 4 (explaining the BID-in-C.0.k^{n′}s being independent), which
(a) automatically prompts the user to select from the {BED-cr-C.0.k l 1≦k≦K}, occurrences of which passed claim 4, a subset {BID-cr-C.0.k*, 1≦k*≦K*≦K};
(b) automatically determines, which value of k* identifies which value of k;
(c) automatically prompts the user, for any k*, through any combinations of BID-cr-C.0.k*′, 1≦k*′≠k*≦K*, thus enabling the user to state thereafter that and why BID-cr-C.0.k* is independent of any BID-cr-C.0.k*′ and combinations thereof;
(d) automatically appends {BID-cr-C.0.k*, 1≦k*≦K*} to {BED-cr-C.0.k, 1≦k≦K} as of (a);
(e) automatically appends this statement of (c), JUS^{ind}({BID-cr-C.0.k*, 1≦k*≦K*}), to {BID-cr-C.0.k*, 1≦k*≦K*};
(f) automatically updates BED-TT.0 in the memory by {BID-cr-C.0.k* as expanded by (e), 1≦k*≦K*}.

6) A method according to claim 5 (explaining the BID-in-C.0.k^{n′}s being nonequivalent)
(a) automatically prompts the user, for any BID-cr-C.0.k*, through any doc.0-MUIs, thus that the user may state thereafter that and why it is non-equivalent to a BID-cr-C.0.k*′, 1≦k*′≠k*≦K*;
(b) automatically appends this statement of (a), JUS^{nequ}({BID-cr-C.0.k*, 1≦k*≦K*}), to {BID-cr-C.0.k*, 1≦k*≦K*};
(c) automatically updates BED-TT.0 in the memory by {BID-cr-C.0.k* as expanded by (b), 1≦k*≦K*}.

7) A method according to claim 6 (showing the claimed invention being novel and nonobvious), which
(a) automatically prompts the user to execute the NANO test on the current PTR^{CT}-DS;
(b) automatically appends the result of (a), JUS^{NANO}({BID-cr-C.0.k*, 1≦k*≦K*}), to {BID-cr-C.0.k*, 1≦k*≦K*};
(c) automatically updates BED-TT.0 in the memory by {BID-cr-C.0.k* as expanded by (b), 1≦k*≦K*}.

8) A method according to claim 7 (showing the claimed invention being not natural law(s) only), which
(a) automatically prompts the user to state that and why the claimed invention is not natural law only;
(b) automatically appends this statement of (a), JUS^{NNLO}({BID-cr-C.0.k*, 1≦k≦K*}), to {BID-cr-C.0.k*, 1≦k*≦K*};
(c) automatically updates BED-TT.0 in the memory by {BID-cr-C.0.k* as expanded by (b), 1≦k*≦K*}.

9) A method according to claim 8 (showing the claimed invention being not idempotent), which
(a) automatically prompts the user to select from {BID-cr-C.0.k*, 1≦k*≦K*} a set {BID-cr-C.0.k″, 1≦k″≦K″≦K*};
(b) automatically prompts the user to execute the NANO test [set of (a)] on the current PTR^{CT}-DS;
(c) automatically appends the set of (a) to {BID-cr-C.0.k*, 1≦k*≦K*};
(d) automatically appends the result of (b), JUS^{NI}({BID-cr-C.0.k″, 1≦k″≦K″}), to {BID-cr-C.0.k”, 1≦k″≦K″};
(e) automatically updates BED-TT.0 in the memory by {BID-cr-C.0.k* as expanded by (c) and (d), 1≦k*≦K*}.

10) A method according to claim 9 (showing the claimed invention being not an abstract idea only), which
(a) automatically prompts the user to state the problem P.0 to be solved by the claimed invention;
(b) automatically prompts the user to identify the set of doc.0-MUIs describing this P.0, SoDIS(P.0);
(c) automatically appends this statement of (a) to {BID-cr-C.0.k″, 1≦k″K″};
(d) automatically appends SoDIS(P.0) to {BID-cr-C.0.k″, 1≦k″≦K″};
(e) automatically prompts the user, for any BID-cr-C.0.k″, through any doc.0-MUI, thus enabling it to state that this BID-cr-C.0.k″ is indispensable in the claimed invention for making it solve P.0;
(f) automatically appends this statement, JUS^{NAIO}(P.0), to {BID-cr-C.0.k″, 1≦k″≦K″};
(g) automatically updates BED-TT.0 in the memory by {BID-cr-C.0.k* as expanded by (a)-(f), 1≦k″≦K″}.

11) A method according to claim 1, subject to the additional limitations that part of the information input uses a given predesigned wording.

12) A method according to claim 1, subject to the additional limitations that part of the information input comprises confirmation of correctness by some given authority.

13) A method according to claim 1, subject to the additional limitations that part of the information input represents enrichments of various kinds of the PTR-DS.

14) A method according to claim 1, subject to the additional limitations that part of the information input represents given modifications of the volume of a set of alternatives.

15) A method according to claim 1, subject to the additional limitations that part of the information input represents given determinations of test specific execution sequences.

16) A system executing a computer-implemented method for updating a given data structure PTR^{CT}-DS in a BAD-KR, both in given formats, by a set of Binary Elementary Disclosed (“BED”) inventive concepts of PTR's TT.0, called BED-TT.0, input to it by the user and by appendices to it and to BAD-KR for controlling an Innovation Expert System IES—the method (performing, for a claimed invention of PTR, its refined claim construction by here first disaggregating its compound inventive concepts, if these are not yet elementary) using a memory for storing the so updated PTR^{CT}-DS, generated by executing this method on TT.0's compound inventive concepts BAD-X.0.n of TT.0 representing their mirror predicates BAD-X.0.n of its X.0.n, 1≦n≦N—which:
(a) writes the PTRCT-DS in a given BAD-KR into the memory
(b) automatically prompts the user to determine the KR_R&S_S to be obeyed during its execution, being
(b).3 either given by the IES as a default KR_R&S_S for both strategies, based on the BAD-KR of (a),
(b).4 or a KR_R&S_S input, in a given notation, by the user additionally to the BAD-KR of (a);
(c) automatically identifies in said PTR^{CT}-DS and said KR_R&S_S, in given formats,
(c).4 for a given 0≦I≦IRSI, all document's and all their doc.i-MUIs, 0≦i≦Il, and
(c).5 the document.CT in doc.0 and all its doc.CT-MUIs, and
(c).6 all elements X.0.n and their predicates BAD-X.0.n, 1≦n≦N, for any BAD-KR in KR_R&S_S;
(d) automatically performs for any BAD-KR in KR_R&S_S, controlled by this KR_R&S_S, the steps (d).1-(d).6:
(d).7 prompt the user to input a set of BED-cr-C.0.k′s—in a given notation—of TT.0, 1≦k≦K, and
(d).8 prompt the user to disaggregate any BAD-X.0.n, 1≦n≦N, into a set {BED-cr-C.0.kⁿ|1≦kⁿ≦Kⁿ}⊂{BED-cr-C.0.k|1≦k≦K}: BAD-X.0.n=Λ^{1≦kn≦Kn}BED-cr-C.0.kⁿ, whereby BED-cr-C.0.kⁿ≠BED-cr-C.0.k^{n′∀V n′, and |∪}^{1≦n≦N}{BED-cr-C.0.kⁿ|1≦kⁿ≦Kⁿ}}l=K,
(d).9 prompt the user to input, in a given notation, ∀BAD-X.0.n a set of justifications by doc.0-/.CT-MUIs of this disaggregation into {BED-cr-C.0.kⁿ|1≦kⁿ≦Kⁿ}, denoted as SoJUS^{dagr}(BAD-X.0.n), 1≦n≦N;
(d).10 automatically append any SoJUS^{dagr}(BAD-X.0.n) to BAD-X.0.n, 123 n≦N;
(d).11 automatically generate BED-TT.0::={{BED-cr-C.0.k|1≦k≦K}}∪{{BED-cr-C.0.kⁿ|1≦kⁿ≦Kⁿ}|1≦n≦N};
(d).12 automatically update the PTR^{CT}-DS in the memory as of (a), according to (d).4 and (d).5.

17) A system executing a computer-implemented method according to claim 16 (explaining the lawful disclosures of the BED-cr-C.0.kⁿ and completing them to BED-in-C.0.kⁿ by), updating PTR^{CT}-DS by the sets SoDIS(TT.0) and SoJUS(TT.0), which
(a) automatically prompts the user through each BED-cr-C.0.kⁿ in each BAD-X.0.n of the KR at issue, 1≦kⁿ≦Kⁿ, 1≦n≦N—to identify for BED-cr-C.0.kⁿ a set of disclosures, SoDIS(BED-C.0.kⁿ)::={MUI.0s disclosing this BED-cr-C.0.kⁿ}, SoDIS(BED-cr-C.0.kⁿ) being justified by SoJUS^{dagr}(BAD-X.0.n) and hence linked to it;
(b) automatically prompts the user to select at least one disclosure DIS^{sel}(BED-cr-C.0.kⁿ) from any set SoDIS(BED-cr-C.0.kⁿ) of (a), and to identify for it a set of legal justifications, SoJUS(DIS^{sel}(BED-cr-C.0.kⁿ))::=I.CTs and/or MUI.CTs and MUI.0s justifying DIS^{sel}(BED-cr-C.0.kⁿ)} and hence linked to it;
(c) automatically appends to any BED-cr-C.0.kⁿ its SoDIS(BED-cr-C.0.kⁿ), 1≦kⁿ≦Kⁿ, 1≦n≦N;
(d) automatically appends to any selected disclosure DIS^{sel}(BED-cr-C.0.kⁿ) the SoJUS(DIS^{sel}(BED-cr-C.0.kⁿ)) of (b), 1≦kⁿ≦Kⁿ, 1≦n≦N;
(e) automatically updates BED-TT.0 in the memory by {BED-cr-C.0.k expanded by its appendix (c)-(d), 1≦k≦K}.

18) A system executing a computer-implemented method according to claim 17 (explaining the definitiveness of the BED-in-C.0.kⁿ involved in a means-plus-function-clause), which
(a) automatically prompts the user for any BED-cr-C.0.kⁿ of claim 17 involved in a means-plus-function-clause, 1≦kⁿ≦Kⁿ, through its disclosures DIS^{sel}(BED-cr-C.0.mⁿ), 1≦mⁿ≦Mⁿ, 1≦n≦N, until a DIS^{sel0}(BED-cr-C.0.mⁿ) enables the user to state this BED-cr-C.0.k^{n′}s definitiveness;
(b) automatically appends this statement of (a), JUS^{def}(DIS^{sel0}(BED-cr-C.0.mⁿ)), to BED-cr-C.0.kⁿ;
(c) automatically updates BED-TT.0 in the memory by {BED-cr-C.0.kⁿ expanded by JUS^{def}(DIS^{sel0}(BED-cr-C.0.mⁿ)), 1≦kⁿ≦Kⁿ, 1≦n≦N}.

19) A system executing a computer-implemented method according to claim 18 (explaining the BED-in-C.0.k^{n′}s being enabling), which
(a) automatically prompts the user through any of its BED-cr-C.0.kns and any of its disclosures DISsel(BED-cr-C.0.kn), 1≦kn≦Kn, 1≦n≦N—until one DISsel(BED-cr-C.0.kn) entitles the user to state that BED-cr-C.0.kn is enablingly disclosed;
(b) automatically appends this statement of (a), JUS^{end}(DIS^{sel}(BED-cr-C.0.kⁿ)), to DIS^{sel}(BED-cr-C.0.kⁿ);
(c) automatically updates BED-TT.0 in the memory by {BED-cr-C.0.kⁿ expanded by DIS^{sel}(BED-cr-C.0.kn) which is expanded by JUS^{end}(DIS^{sel}(BED-cr-C.0.kⁿ)), 1≦n≦N, 1≦kⁿ≦Kⁿ}.

20) A system executing a computer-implemented method according to claim 19 (explaining the BID-in-C.0.k^{n'}s being independent), which
(a) automatically prompts the user to select from the {BED-cr-C.0.k|1≦k≦K}, occurrences of which passed claim 4, a subset {BID-cr-C.0.k*, 1≦k*≦K*≦K};
(b) automatically determines, which value of k* identifies which value of k;
(c) automatically prompts the user, for any k*, through any combinations of BID-cr-C.0.k*′, 1≦k*′≠k*≦K*, thus enabling the user to state thereafter that and why BID-cr-C.0.k* is independent of any BID-cr-C.0.k*′ and combinations thereof;
(d) automatically appends {BID-cr-C.0.k*, 1≦k*≦K*} to {BED-cr-C.0.k, 1≦k≦K} as of (a);
(e) automatically appends this statement of (c), JUS^{ind}({BID-cr-C.0.k*, 1≦k*≦K*}), to {BID-cr-C.0.k*, 1≦k*≦K*};
(f) automatically updates BED-TT.0 in the memory by {BID-cr-C.0.k* as expanded by (e), 1≦k*≦K*}.

21) A system executing a computer-implemented method according to claim 20 (explaining the BID-in-C.0.k^{n′}s being nonequivalent)
(a) automatically prompts the user, for any BID-cr-C.0.k*, through any doc.0-MUIs, thus that the user may state thereafter that and why it is non-equivalent to a BID-cr-C.0.k*′, 1≦k*′≠k*≦K*;
(b) automatically appends this statement of (a), JUS^{nequ}({BID-cr-C.0.k*, 1≦k*≦K*}), to {BID-cr-C.0.k*, 1≦k*≦K*};
(c) automatically updates BED-TT.0 in the memory by {BID-cr-C.0.k* as expanded by (b), 1≦k*≦K*}.

22) A system executing a computer-implemented method according to claim 21 (showing the claimed invention being novel and nonobvious), which
(a) automatically prompts the user to execute the NANO test on the current PTR^{CT}-DS;
(b) automatically appends the result of (a), JUS^{NANO}({BID-cr-C.0.k*, 1≦k*≦K*}), to {BID-cr-C.0.k*, 1≦k*≦K*};
(c) automatically updates BED-TT.0 in the memory by {BID-cr-C.0.k* as expanded by (b), 1≦k*≦K*}.

23) A system executing a computer-implemented method according to claim 22 (showing the claimed invention being not natural law(s) only), which
(a) automatically prompts the user to state that and why the claimed invention is not natural law only;
(b) automatically appends this statement of (a), JUS^{NNLO}({BID-cr-C.0.k*, 1≦k*≦K*}), to {BID-cr-C.0.k*, 1≦k*≦K*};
(c) automatically updates BED-TT.0 in the memory by {BID-cr-C.0.k* as expanded by (b), 1≦k*≦K*}.

24) A system executing a computer-implemented method according to claim 23 (showing the claimed invention being not idempotent), which
(a) automatically prompts the user to select from {BID-cr-C.0.k*, 1≦k*≦K*} a set {BID-cr-C.0.k″, 1≦k″≦K″≦K*};
(b) automatically prompts the user to execute the NANO test [set of (a)] on the current PTR^{CT}-DS;
(c) automatically appends the set of (a) to {BID-cr-C.0.k*, 1≦k *—K*};
(d) automatically appends the result of (b), JUS^{NI}({BID-cr-C.0.k″, 1≦k″≦K″}), to {BID-cr-C.0.k″, 1≦k″≦K″};
(e) automatically updates BED-TT.0 in the memory by {BID-cr-C.0.k* as expanded by (c) and (d), 1≦k*≦K*}.

25) A system executing a computer-implemented method according to claim 24 (showing the claimed invention being not an abstract idea only), which
(a) automatically prompts the user to state the problem P.0 to be solved by the claimed invention;
(b) automatically prompts the user to identify the set of doc.0-MUIs describing this P.0, SoDIS(P.0);
(c) automatically appends this statement of (a) to {BID-cr-C.0.k″, 1≦kΔ≦K″};
(d) automatically appends SoDIS(P.0) to {BID-cr-C.0.k″, 1≦k″≦K″};
(e) automatically prompts the user, for any BID-cr-C.0.k″, through any doc.0-MUI, thus enabling it to state that this BID-cr-C.0.k″ is indispensable in the claimed invention for making it solve P.0;
(f) automatically appends this statement, JUS^{NAIO}(P.0), to {BID-cr-C.0.k″, 1≦k″≦K″};
(g) automatically updates BED-TT.0 in the memory by {BID-cr-C.0.k* as expanded by (a)-(f), 1≦k″≦K″}.

26) A system executing a computer-implemented method according to claim 16, subject to the additional limitations that part of the information input uses a given predesigned wording.

27) A system executing a computer-implemented method according to claim 16, subject to the additional limitations that part of the information input comprises confirmation of correctness by some given authority.

28) A system executing a computer-implemented method according to claim 16, subject to the additional limitations that part of the information input represents enrichments of various kinds of the PTR-DS.

29) A system executing a computer-implemented method according to claim 16, subject to the additional limitations that part of the information input represents given modifications of the volume of a set of alternatives.

30) A system executing a computer-implemented method according to claim 16, subject to the additional limitations that part of the information input represents given determinations of test specific execution sequences.
